(19) United States
(12) Patent Application Publication
(10) Pub. No.: US 2007/0226004 A1
(43) Pub. Date: Sep. 27, 2007

(54) IDENTIFICATION, STORAGE AND DISPLAY OF LAND DATA ON A WEBSITE

(75) Inventor: Craig Harrison, Fort Collins, CO (US)

Correspondence Address: COCHRAN FREUND & YOUNG LLC, 2026 CARIBOU DR, SUITE 201, FORT COLLINS, CO, 80525, US

(73) Assignee: LANDNET CORPORATION, Fort Collins, CO (US)

(21) Appl. No.: 11/750,874

(22) Filed: May 18, 2007

Related U.S. Application Data
(63) Continuation-in-part of application No. 11/621,515, filed on Jan. 9, 2007.
Application No. 11/621,515 is a continuation of application No. 10/162,723, filed on Jun. 3, 2002, now Pat. No. 7,171,389.
(60) Provisional application No. 60/295,097, filed on Jun. 1, 2001.
(60) Provisional application No. 60/336,258, filed on Oct. 31, 2001.
(60) Provisional application No. 60/370,083, filed on Apr. 4, 2002.
(60) Provisional application No. 60/356,405, filed on Feb. 11, 2002.

(51) Int. Cl. G06F 17/00; G06F 15/16

(52) U.S. Cl. 705/1

(57) ABSTRACT

Disclosed is a land website that provides a personalized database on which data can be stored, retrieved, customized and communicated (e.g., by e-mail) relating to a particular piece of property. The database can be accessible via a password and a security code over the Internet and may be encrypted for transmission. Land websites can be established that contain image data, map libraries, virtual tours, legal descriptions, title information, e-documents, actual pictures of property and various other information. Information stored on the land website may be obtained by searching the Internet. The land website provides a unique way of packaging information relating to a piece of land in a single, accessible location. A boundary applet tool is provided on the land website portal that allows a user to simply and easily draw boundaries and/or create boundaries automatically around the property of interest and then submit an order for more detailed information about the property of interest. Properties of interest can be easily accessed by a global coordinate system or by searching on map data that is provided on a wide range of scales. Further, boundaries may be monitored for items changing or moving on the property and/or items entering or leaving the property.

### CROSS REFERENCE TO RELATED APPLICATIONS

This application is a continuation-in-part of U.S. continuation application Ser. No. 11/621,515, filed Jan. 9, 2007, entitled “Identification, Storage and Display of Land Data on a Website,” which was a continuation of U.S. non-provisional application Ser. No. 10/162,723, filed Jun. 3, 2002, entitled “Identification, Storage and Display of Land Data on a Website,” which was based upon and claims priority to: U.S. provisional application Ser. No. 60/295,097, filed Jun. 1, 2001, entitled “Identification, Storage and Display of Land Data on a Website;” U.S. provisional application 60/336,258, filed Oct. 31, 2001, entitled “Identification, Storage and Display of Land Data on a Website;” U.S. provisional application Ser. No. 60/370,083, filed Apr. 4, 2002, entitled “Web Imaging Serving Technology;” and U.S. provisional application Ser. No. 60/356,405, filed Feb. 11, 2002, entitled “Internet Delivered and Accessible set of Maps, Images, and Tools for Locating, Identifying, Measuring, Viewing, and Communicating Information About Land and Areas of Land.” All of these are specifically incorporated herein by reference for all that they disclose and teach.

### BACKGROUND OF THE INVENTION

An extensive amount of data has been collected from various sources such as satellites, land surveys, legal descriptions and other sources that provide detailed information relating to land. For example, maps provided by the Bureau of Land Management provide map data that indicates legal boundaries relating to land ownership. Satellite data provides imagery indicating land features, growth and vegetation, water sources and other geographical features. Infrared imagery has been used to careful study growth and vegetation features, for example. Topological information has been accumulated through radar satellites and topological surveys. Hence, there is a huge body of information relating to land and associated features such as rivers, roads, vector data and raster data.

Various imaging techniques have been used that combine various sources of data and allow a user to view images of these combined data sources. For example, 3-D images have been generated that combine political and physical characteristics with satellite imagery. Land can be viewed, using this technique, at an elevated angle such that the image depicts the various features relating to land. Further, growth and vegetation data can be added to such images from other data sources to provide a more enhanced view. As another example, BLM map data can be combined with satellite imagery data to indicate legal boundaries on the satellite imagery. Further, topological data can be used to provide shading on a two-dimensional image that provides imagery relating to topological features, which is commonly referred to as 2.5-D images.

### SUMMARY OF THE INVENTION

An embodiment of the present invention may comprise a method of generating a personalized land website at an Internet accessible location on the Internet, the personalized land website providing an archive of a variety of information relating to a selected area of land comprising: creating the Internet accessible location of the personalized land website for storage of the archive of the variety of information; providing map data over the Internet that relates to the selected area of land; providing boundary drawing tools to allow a boundary to be circumscribed at least partially around the selected area of land on the map data; drawing a boundary at least partially around the selected area of land using the boundary drawing tools; storing the map data as part of the personalized land website; and providing additional storage locations as part of the personalized land website for storage of additional information relating to the area of land.

An embodiment of the present invention may further comprise a personalized land website that provides an Internet accessible location for archiving a variety of information relating to a selected area of land comprising: means for creating the Internet accessible location of the personalized land website; means for providing map data over the Internet that relates to the selected area of land; means for drawing a boundary at least partially around the selected area of land; means for storing the map data as part of the personalized land website; and means for providing additional storage locations as part of the personalized land website for storage of additional information relating to the area of land.

An embodiment of the present invention may further comprise a method of generating a personalized land website at an Internet accessible location on the Internet, the personalized land website providing an interface for monitoring a selected area of land comprising: creating the Internet accessible location of the personalized land website for monitoring the selected area of land; providing map data over the Internet that relates to the selected area of land; providing boundary drawing tools to allow a boundary to be circumscribed at least partially around the selected area of land on the map data; drawing a boundary at least partially around the selected area of land using the boundary drawing tools; monitoring a physical boundary and a physical land area at least partially enclosed by the physical boundary of the selected area of land corresponding to the boundary on the map data in order to detect changes to the selected area of land; and notifying an interested party whenever the changes to the selected area of land are detected.

An embodiment of the present invention may further comprise a personalized land website that provides a management and supervisory interface via an Internet accessible location on the Internet for monitoring a selected area of land comprising: means for creating the Internet accessible location of the personalized land website; means for providing map data over the Internet that relates to the selected area of land; means for drawing a boundary at least partially around the selected area of land; means for monitoring a physical boundary and a physical land area at least partially enclosed by the physical boundary; and means for notifying an interested party whenever changes to the selected area of land are detected.

An embodiment of the present invention may further comprise a personalized land website that provides an Internet accessible location for archiving a variety of information relating to a selected area of land comprising: map data that relates to the selected area of land; additional information that relates to the selected area of land; an Internet accessible computer system that provides an Internet location for the personalized land website including the map data that relates to the selected area of land and that allows users to view the map data and additional information relating to the selected area of land in Internet connected web browsers; boundary drawing tools that draw a boundary at least partially around the selected area of land on the map data; and at least one computer readable storage medium to store the personalized land website including the map data and the additional information.

An embodiment of the present invention may further comprise a personalized land website that provides a management and supervisory interface via an Internet accessible location on the Internet for monitoring a selected area of land comprising: map data that relates to the selected area of land; an Internet accessible computer system that provides an Internet location for the personalized land website including the map data that relates to the selected area of land and that allows users to view the map data and additional information relating to the selected area of land in Internet connected web browsers; boundary drawing tools that draw a boundary at least partially around the selected area of land on the map data; and at least one computer readable storage medium to store the personalized land website including the map data; a monitoring subsystem that monitors a physical boundary and a physical land area at least partially enclosed by the physical boundary of the selected area of land corresponding to the boundary on the map data in order to detect changes to the selected area of land; and a notification subsystem that notifies an interested party whenever the changes to the selected area of land are detected.

### BRIEF DESCRIPTION OF THE DRAWINGS

In the drawings,

FIG. 1 is a schematic illustration of the manner in which an embodiment provides a central archive of personalized land websites.

FIG. 2 is a diagram illustrating the layout of the land website portal.

FIG. 3 is a flow diagram illustrating the functions of the land website portal.

FIG. 4 is a flow chart illustrating the manner of generating boundary data to create a land website.

FIG. 5 is a flow chart illustrating the method of georeferencing global coordinates.

FIG. 6 is a flow diagram illustrating the generation of frame windows.

FIG. 7 is a flow diagram illustrating the manner in which image data can be modified.

FIG. 8 is a flow diagram illustrating the steps that may be used for locating property and visually generating boundary data.

FIG. 9 is a flow chart illustrating the steps that may be used for generating boundary data from GPS way point data.

FIG. 10 is a flow diagram illustrating the steps for generating boundary data from metes and bounds descriptions.

FIG. 11 is a flow diagram illustrating the steps that can be used to market personalized land websites.

FIG. 12 illustrates the steps that may be employed in the marketing of various offers for products and services.

FIG. 13 is a flow diagram illustrating the steps for searching for information related to a selected area of land on the Internet.

FIG. 14 illustrates the expansion of a boundary via a buffer zone used for searching for information on a selected area of land that also includes neighboring properties contained in the buffer zone.

FIG. 15 is a flow diagram illustrating the steps for monitoring the physical boundary and physical land area within the physical boundary of a property for a boundary created on the land website.

FIG. 16 is a flow diagram illustrating the steps for automatically creating a boundary on the land website from a boundary contained on a scanned image or photograph.

FIG. 17 is a flow diagram illustrating the steps for automatically creating a boundary on the land website from boundary information contained in a database or other computer readable file.

FIG. 18 is a flow diagram illustrating the steps for ordering an aerial or satellite image or photograph of a selected area of land and adding the image or photograph to the personalized land website archive for the selected area of land.

FIG. 19 is a flow diagram illustrating the steps for a land website to receive notification from a third party provider of new information available for a selected area of land.

FIG. 20 is a schematic illustration of third party notification of new information on a selected area of land included in a land website.

### DETAILED DESCRIPTION OF THE INVENTION

Embodiments disclosed herein provide a system that has a central archive for storing map data, satellite images, e-documents, photographs, modified images, important Internet links, and any other desired data relating to a property. Various embodiments generate a partitioned storage area on an Internet server for each property that is either publicly accessible, or password and security code accessible, so as to provide a personalized, customizable land website. Because every parcel of land is unique, the personalized land website provides a digital “fingerprint” of the property.

Various embodiments can employ various techniques for locating and identifying a property of interest. For example, the system of the present invention may allow a user to visually identify a property by using various map data or images of land. A drawing tool can be employed by the user to generate boundaries that circumscribe the property. The drawing tools may permit a user to manually or automatically create boundaries. The circumscribed property is then framed within a boundary window so that additional imagery can be generated that allows the user to view various images of the circumscribed property within the boundary frame window (“frame window”). Viewers can then take virtual tours of the property by simply using an Internet accessible computer having a web browser. For example, rotating 3-D imagery of the property within the frame window can be generated such that the property can be viewed at an elevated angle showing topological features, vegetation and growth, legal boundaries and other information from 360 degrees. Global coordinates from one set of map data to another set can be used so that boundary points identified on one set of images appears on other sets of image data at corresponding locations to assist the user in properly identifying the property boundaries of interest. Additionally, various embodiments may permit a user to monitor the physical boundary of the property for items entering or leaving the property. Various embodiments may also monitor items moving within the physical property boundary. Various embodiments may further track items that are near the boundary in the same manner as items moving within or across the physical boundary lines by including a buffer zone around the physical boundary to extend the monitored physical area.

The disclosed embodiments may be used for various purposes to archive and deliver land information to various people such as brokers, appraisers, lenders, developers, land owners, consultants, potential buyers, construction personnel making improvements on the property, government personnel making planning decisions, land managers, etc. In each of these cases, other additional data from the user or third parties can be provided on the land website. For example, legal documents can be provided relating to the land. In that regard, terms of the purchase can be provided together with leases, title abstracts, easements, rights of way and other legal documentation in a specific area set aside for e-documents. The disclosed embodiments may further use the Internet to search for the additional data related to the land or to neighboring land. The additional data found in the search may be placed in the land website archive and/or the system may provide notice to interested parties, including third parties, that additional data has been found. Additionally, the disclosed embodiments can be implemented in a simple and easy fashion over the Internet which will allow users to readily access data for generating circumscribed boundaries and frame windows for viewing the property.

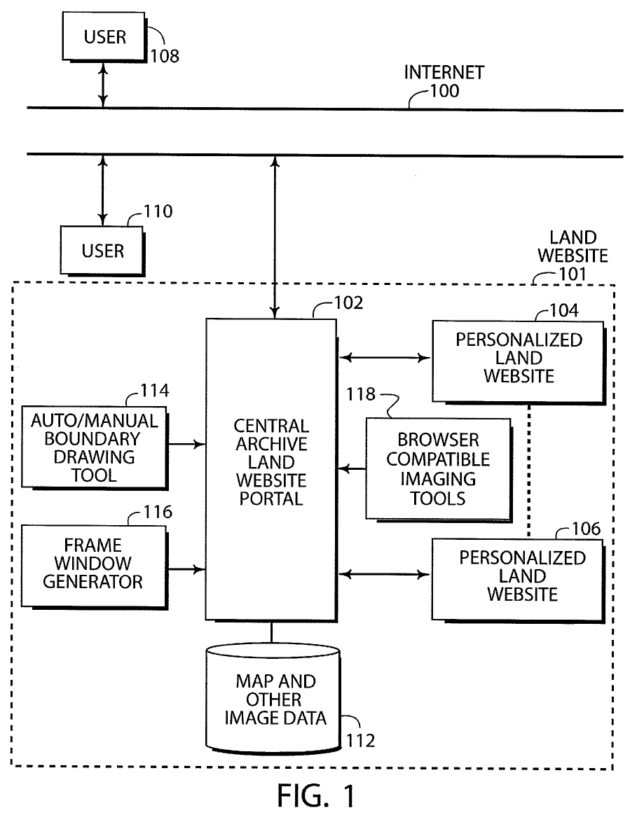

FIG. 1 is a schematic illustration of one embodiment of the present invention. As shown in FIG. 1, a central archive land website 101 is connected to the Internet that provides interactive connection to the central archive land website 101. The central archive land website 101 is connected to a land website portal 102 that functions as a portal for the land website 102. The land website portal 102 may have a number of personalized land websites 104, 106 that are provided to users via the Internet 100 by a connection through the land website portal 102. The personalized land websites 104, 106 may be generated and paid for by users such as user 108 who is also connected to the Internet 100. The user 108 may select a particular piece of land for which the user would like to establish a personalized land website. As disclosed below, the user 108 generates boundary data to identify the particular piece of property of interest. The land website portal 102 may include a server having a storage device 112 connected thereto having a large amount of storage space. Each personalized land website, such as personalized land websites 104, 106, are stored on the storage device 112 and may then be password and security code protected to restrict access by other users. Further, portions of the personalized land websites may also be protected by additional passwords. User 108 may allow other users such as user 110 to directly access a personalized land website. Alternatively, user 108 may wish to e-mail portions of the data stored on a personalized land website to a user such as user 110. In that regard, the Internet address of the personalized land website may be e-mailed to a user, together with the security code for accessing the personalized land website.

In various embodiments, passwords may be placed in various categories with different permissions to perform various actions. Some of the possible permission categories include: public access, private access, and inactive user. A user with private access might have permissions to perform more functions than a user with only public access permissions. An inactive user may have all permissions removed and be denied any access to the land website. Other security features may also be included in various embodiments. For instance, a user access log to track which users have accessed or attempted to access the system may be implemented. Detailed tracking of the user's actions while logged in to the website may also be tracked and reviewed for suspicious activity. Use of passwords and other security features allow multiple types of users to access a land website with varying degrees of functionality. Various embodiments may permit a third party to have limited access if the land website owner desires to permit third party access. The third party access may be password protected such that only authorized third parties have access to the system. Alternatively, the land website owner may wish to open access to certain areas of the land website to the public by removing password protection and allowing all visitors access to the land website. Other users with higher privileges may access the land website with a different password and/or username that permits the higher level user access to more of the land website features.

The personalized land websites, such as personalized land website 104, 106, may contain various data including various map data illustrating the boundaries of the property, satellite image data, photographic data, third party maps, e-documents (text material) relating to the property such as legal descriptions, leases, surveys, grazing leases, title abstracts, title and deed information, public land leases, easements and rights-of-way, watershed studies, other studies, loan information, appraisal reports, insurance, conservation easements, ownership rights, mineral rights of land, water rights of land, land titles, environmental audit, insurance documents, improvements, leases, flood plain data, scanned documents, loan documents, e-appraisal reports, and other similar e-document information. Additionally, data may include links to live information and/or third party data only available from a third party website. For instance, links to webcams for viewing the land, links to video streaming for viewing the land, links to blog websites, links to Really Simple Syndication feeds, links to Rich Site Summary feeds, links to RDF (Resource Description Framework) Site Summary feeds, links to podcasts, and links to other resources that display data obtained from sources other than the land website may also be contained in the additional data stored in the archive. Data from other sources may be incorporated into the land website using Application Programming Interfaces (APIs) provided by the third parties. Photographic and document data may be scanned and uploaded by the user onto the personalized land website, as disclosed more fully below. Third party maps may be stored by the user on the personalized land website, as well as image data that has been modified by the user. In short, any type of information relating to the land may be stored by the user on the personalized land website. Further, the personalized land website may be directed to any property of interest and does not have to be owned by the user that establishes the personalized land website. The personalized land website may be used for studying property, offering property for sale, marketing and other various purposes. In this fashion, the present invention provides a central archive of all of the digital information relating to a selected piece of property on a personalized land website that may be archived and retrievable on a site specific basis. In this fashion, a digital fingerprint of the property can be generated.

Map image data and other image data is stored on a storage device 112 coupled to the central archive land website portal 102. The browser compatible imaging tools 118 allow a user such as users 108, 110 to access and view the map and other image data using a standard web browser tool. The users can then utilize the boundary drawing tool 114 to draw a boundary around an area of land of interest. The boundary drawing tool 114 identifies the global coordinates on the map and other image data. The boundary drawing tool 114 may automatically or manually draw the boundary. Boundaries may be automatically drawn based on boundary information contained in a database, spreadsheet, other electronic files, or combination of files and/or databases. The electronic file may contain many types of boundary information. For instance, an embodiment may use a vector database defining the border using vector definitions. Another embodiment may use a database or spreadsheet that includes the geospatial coordinates of the boundary corners. Still another embodiment may include street addresses and/or parcel identification numbers along with a single geospatial coordinate point. The single geospatial coordinate point then acts as the boundary partially enclosing the selected land area. Boundaries may also be automatically obtained by analyzing boundaries shown on scanned images/photographs and translating the boundary into the appropriate geospatial coordinates. These global coordinates are then used by the frame window generator 116 to generate a frame window described below. The map image data and other image data identified in the frame window is then stored in the personalized land website. In various embodiments, access to various types of map/image data may be accomplished via a Geographic Information System (GIS). Access to the GIS may be provided as a link or a tab on the map display screen. The GIS feature may permit users to change map features and otherwise manipulate the map consistent with GIS type functionality.

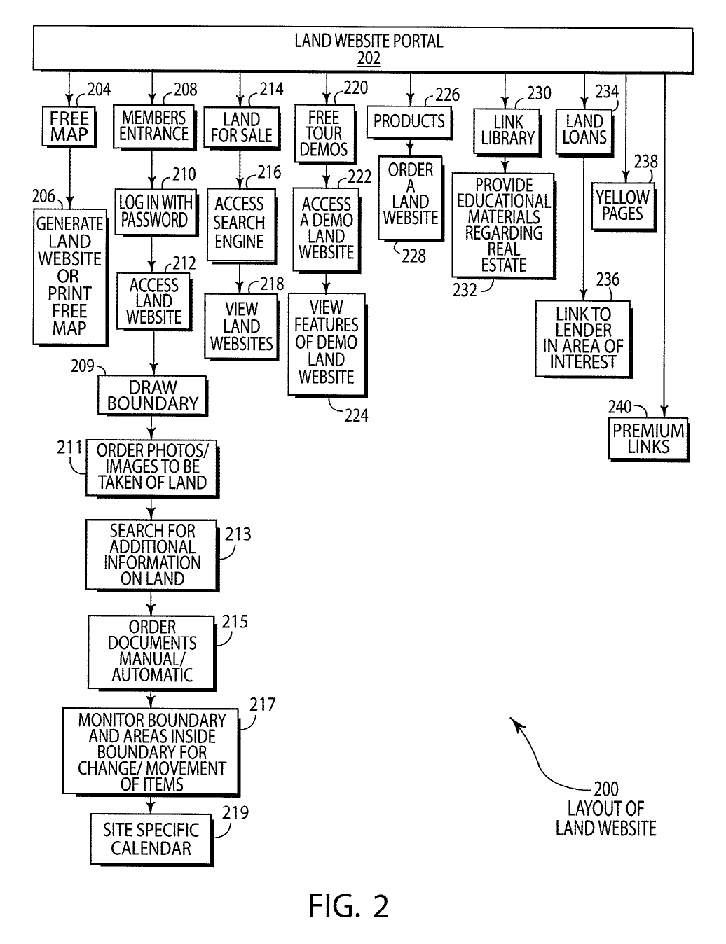

FIG. 2 illustrates the layout 200 of the land website which is operated by a server that is capable of performing the functions disclosed herein. The layout 200 illustrates the manner in which a user of the website can access the functionality provided by the present invention. As shown in FIG. 2, the user can log onto a land website portal 202 that provides the ability to access various functions. For example, the user can access the free map function 204 and subsequently generate a land website or print a free map at step 206, as disclosed above. The user may access the members' entrance 208, login a password at 210, and then access a land website at 212. After accessing the land website, the user may create a boundary 209 around, or partially around, a selected area of land. The user may order aerial/satellite photographs or images to be taken of the selected area of land 211 by selecting a button on the land website. The land website takes care of contacting the aerial/satellite photography vendor and provides the aerial/satellite photography vendor with the geographic coordinates of the boundary of the land to be photographed. After the photograph/images are taken, the land website may add the photographs/images to the land website archive. The land website may be configured such that the owner and/or users may be notified of the availability of the new photographs/images. The new photographs/images may be added to the land website automatically or upon the request of the land website owner and/or users. The user may request that the land website search for additional information on the selected area of land on the Internet 213. In some cases, a third party may be informed of the existence of the land website and thereafter notify the land website when new information pertaining to the selected area of land is available from the third party. New information found in the search 213 may be added to the land website archive. At step 215, the user may order documents stored in the archive from the land website. The land website may further be configured to automatically order new documents when the new documents are located. At step 217, the user may manage the feature of monitoring the physical boundaries and/or the area of land within the physical boundaries of the selected area of land in order to track items entering and/or leaving the land as well as items moving within the selected area of land. The monitoring feature may also be used to track longer term changes such as the addition of a new building based on the changes in a satellite image from one year to the next. The land website owner may be notified of new documents or item/change monitoring messages via a variety of methods including, but not limited to: e-mail, text messaging, instant messaging, phone calls, pages, and facsimiles (Faxes). The user may also access and store information relevant to the selected area of land on a site specific calendar included in the land website 219. The user may wish to view land for sale by accessing the land-for-sale button 214. A search engine is then provided at 216. The user may then view various land websites at step 218.

At 220 of FIG. 2, a viewer may wish to view the functionality provided by the land website by viewing free tour demonstrations 220 for sample properties. At step 222, the viewer accesses a demonstration of a land website that may provide a high degree of functionality such that the viewer may be able to view a demonstration of the land website features 224, including: 3-D, composite images that contain satellite, vegetation and USGS detail, a fly-around movie that has been generated from composite images, pictures of the property that have been downloaded onto the website, legal and other documentation that has been stored at the website and other functionality that has been described above. A user may also select the products button 226 on the land website portal 202 which allows the user to directly order a land website 228, rather than entering through the free map entrance 204. The product entrance 226 may be used, for example, as a direct link from another website which has generated interest via a link from a user who would actually like to purchase a website rather than obtain a free map of the land. The land website portal may also include a link library 230 that allows a user of the land website to access educational materials regarding real estate at step 232. The link library 230 provides an additional reason to access the land website portal and draws additional viewers to the land website portal 202. Other features that may be provided by the land website portal 202 include a link to land loans 234 which provides links to lenders 236 providing loans for buyers in the vicinity of the land of interest, as well as access to yellow pages 238 and additional premium links 240.

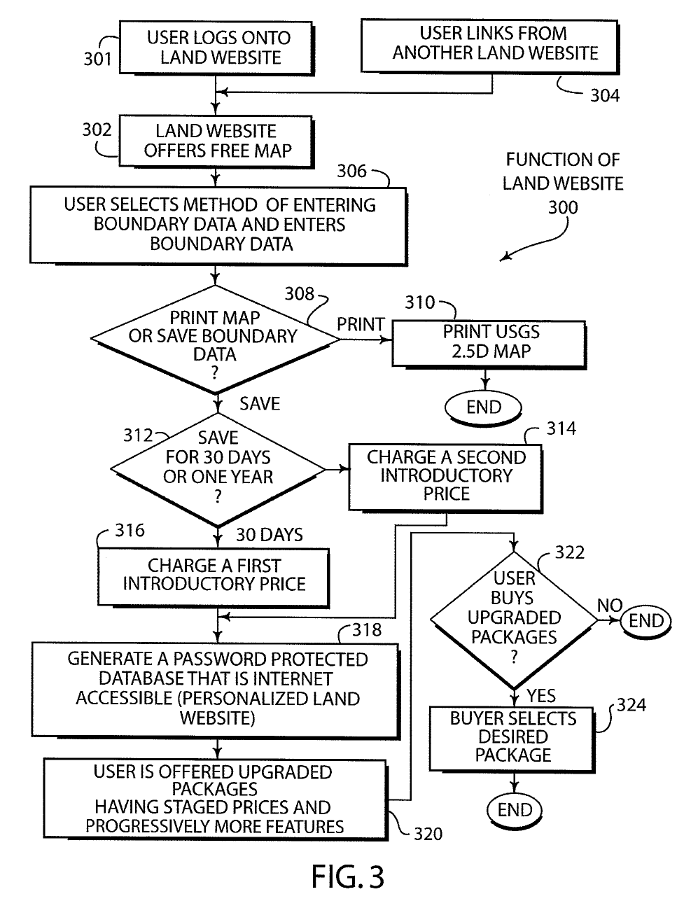

FIG. 3 is a flow diagram illustrating the functions of the land website that is used in accordance with the present invention. At step 300 the user logs onto the land website. The land website provides an offer for a free map at step 302. The free map allows the user to draw boundaries and obtain a USGS type of map that can be enhanced by shadowing or colors to indicate terrain variations. The free map can be provided as a 1:24 K USGS map, or a 1:100 K USGS map if the property is very large.

Alternatively, the user can link from another website into the land website, as illustrated at step 304, rather than entering through the splash page of the land website. For example, links may be provided from organizations that study and evaluate property such as environmentalist organizations, the Nature Conservatory, national laboratories, etc. Further, links may be provided from sales organizations such as real estate brokers, online sales organizations, providers of map data, providers of satellite imaging data, etc.

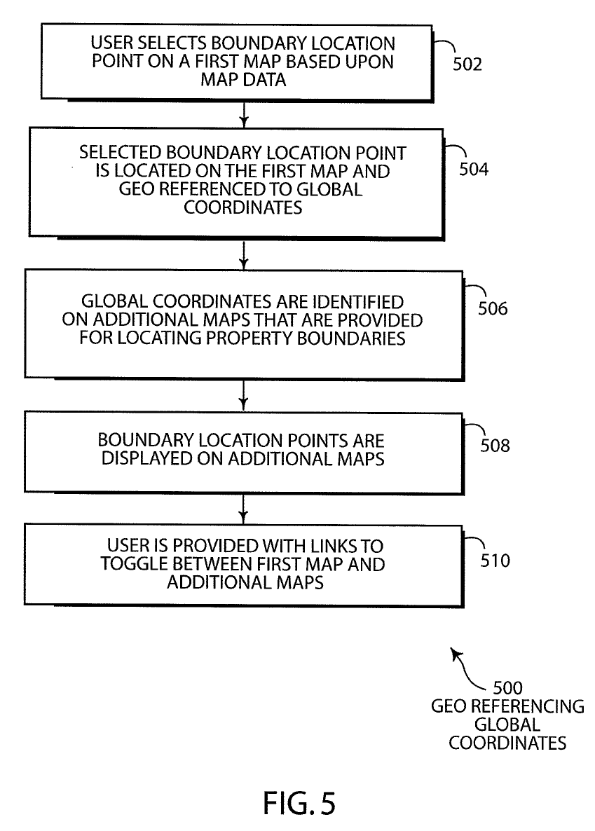

At step 306 of FIG. 3, the user employs a drawing tool to generate boundary data. The drawing tools may manually or automatically generate a boundary. This step is more fully disclosed with regard to the description of FIG. 5. At step 308, the user is given the choice of printing the map or saving the boundary data. If the user decides to print the map at step 310, an enhanced USGS map having shading to indicate elevation changes (2.5-D map) is provided to the user for printing. More specifically, the land website generates an image of the map data that is downloaded to the user's computer which allows the user to print that image. The image and boundary data that has been generated is then erased from the land website server. The user, in this fashion, receives the free print of the property and the process is ended.

If the user, at step 308, decides to save the boundary data, the user is given the option of saving the boundary data at step 312 for a shorter period, such as 30 days, or a longer period such as 1 year. If the user decides to choose the shorter period, a first introductory price is charged at step 316. The process then proceeds to step 318 where a password protected database that is Internet accessible (personalized land website) is generated. If the user, at step 312, decides to save the data for a longer period, a second introductory price is charged at step 314. The process then proceeds to step 318.

At step 320 of FIG. 3, the user is offered upgraded packages having stage prices and progressively more features. For example, the user may be offered bronze, silver, gold and platinum packages which each contain additional features and have progressively higher prices. For example, the bronze package may include a set of maps that includes BLM data indicating legal boundaries for leased property and acreage calculations. The highest package, the platinum package, may provide 3-D satellite images, a 3-D satellite fly-around movie, storage areas on the personal land website that allow the storage of photographs of the property, a storage area for legal documents relating to the property such as titles, leases, title abstract information, easements, right-of-way information and other features described herein. At step 322, the user is given the choice of purchasing an upgraded package. If the user chooses to not buy an upgraded package, the process ends. If the buyer wishes to buy an upgraded package, at step 324 the buyer selects the desired package and a personalized land website is provided having the features corresponding to the particular package purchased by the user. The user then selects a password and security code that the user can provide to other parties to access the user's land website.

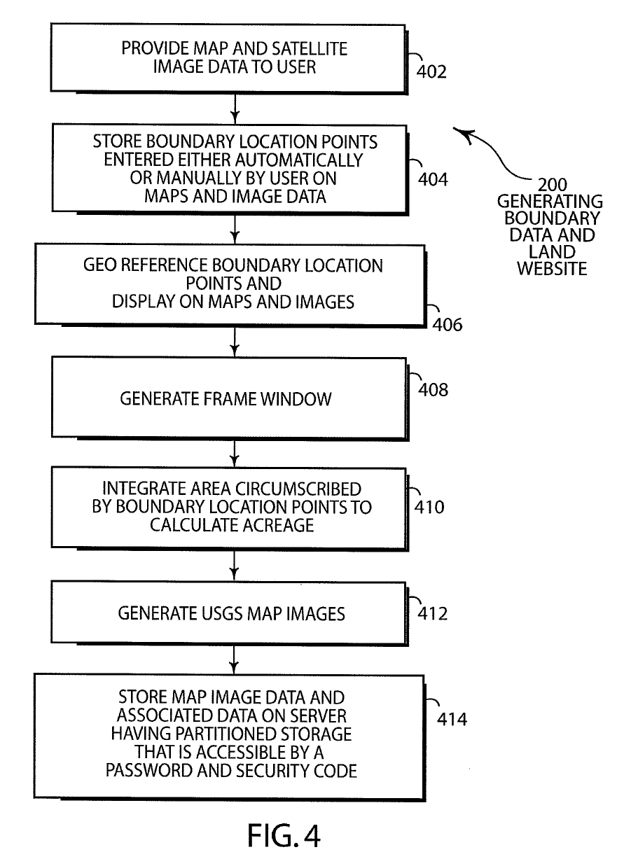

FIG. 4 illustrates the steps 400 that are used to generate boundary data and a land website. At step 402, various map and satellite image data are provided to the user so that the user can identify boundary location points to generate the boundary data. For example, a series of maps such as 1:24 K USGS, 1:100 K USGS, BLM and other types of maps may be provided so that the user can identify location boundary points. Further, satellite image data that includes vegetation and topological features are provided to assist the user in identifying boundary location points. For example, the user may employ a cursor to click on a boundary location point on a particular map or satellite image. Alternatively, the user may actually hold the cursor down and draw a line indicating a boundary location. At step 404, the boundary location points and other boundary data are entered on the maps and the image data, as indicated above. Step 404 may be performed either automatically or manually. At step 406, the boundary location points are georeferenced to a global coordinate system. For example, a system of global coordinates can be used to identify the specific location of the boundary location points. Once the global coordinates of each of the boundary location points are determined, the boundary location points are then generated on the other map and image data, as indicated more specifically in FIG. 5.

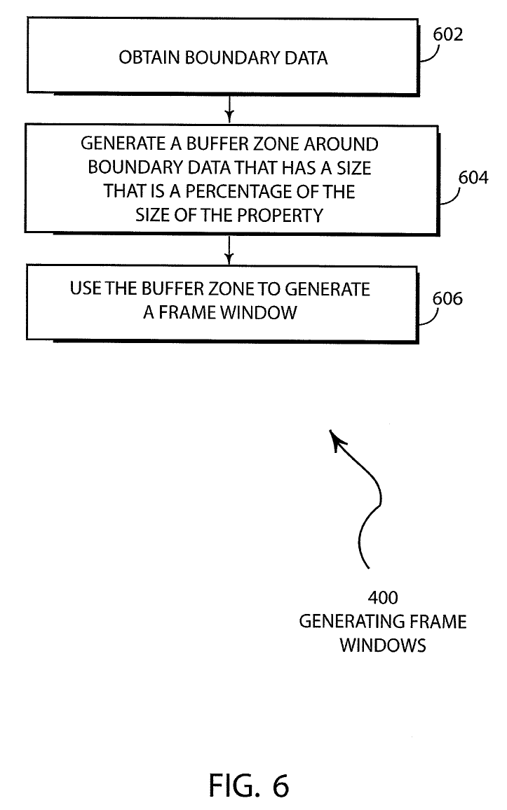

At step 408 of FIG. 4, once the boundary data has been entered and a complete boundary has been provided, a frame window is generated. The frame window is generated to encompass the entire circumscribed property as well as a certain amount of additional land around the circumscribed property to allow the viewer to view the circumscribed property together with a certain amount of surrounding property. The manner of generating a frame window is more fully disclosed with respect to FIG. 6. At step 410, the system then calculates the acreage of the circumscribed property and provides that information to the user. At step 412, USGS map images, such as the 1:24 K USGS map image or the 1:100 K USGS map image, are generated. These images may be generated, for example, as a jpeg image that can be easily stored and viewed by most personal computers. At step 414, the map image is stored together with any other associated data on the land web server in a partitioned storage that is only accessible by a password and security code. In this fashion, a personalized land website is provided by the land web server for the user so that the user can access the land data. Alternatively, as set forth in FIG. 3, the map image data may not be stored but only used to generate a free map. In that case, the process would stop at step 412.

FIG. 5 is a flow diagram 500 illustrating the method of georeferencing global coordinates. At step 502, the user selects a boundary location point on a first map based upon the map data. As indicated above, the map data that is provided may be a 1:24 K or 1:100 K USGS map depending on the size of the property. Additionally, other map and image data, as indicated above, may be provided to locate boundary points for the purpose of drawing the boundary locations. At step 504, a selected boundary location point is located on a first map. The boundary location point is then georeferenced to global coordinates. For example, a global coordinate system can be used to georeference the boundary location points that have been selected by the user on the first map. Step 504 may be performed manually by the user selecting the boundary points on the first map and/or additional maps. Step 504 may also be performed automatically. To automatically generate boundary points, one embodiment may scan an image containing a boundary, analyze the scanned image, and transpose the boundary onto the map data. Another means to automatically generate boundary points may cause an embodiment to read boundary data from a database or other computer readable file and place the boundary data on the map data of the personalized land website. In order to automatically create the personalized land website, a unique web address or Uniform Resource Locator (URL) may need to be created. To ensure that a unique URL is created, various embodiments may incorporate some unique descriptor of the selected area of land, such as a Parcel Identification (PIN) number/string of the selected area of land or a string representing a street address of the selected area of land. Embodiments may also use a random number/string generator to create a unique, random number/string to include in the URL for a personalized land website. Various embodiments may include the unique number/string at various locations in the URL, ranging from the host name identifier to the path to the actual file name. At step 506, the global coordinates are then identified on the additional map and image data, such as satellite image data. The actual location points are displayed on each of the maps and image data in accordance with their geo-referenced global coordinates at step 508. At step 510, the user is then provided with links to toggle between the first map and additional maps to insure that the boundary location points have been properly placed on the maps. Changes can be made on any of the maps. If a boundary location point is changed on a particular map, the corresponding location will appear on all of the other maps. When boundary location points are changed, the change may be permanently stored on the land website.

FIG. 6 illustrates the steps 600 for generating frame windows. At step 602, the boundary data that circumscribes the property of interest is obtained by the frame window software. At step 604, the frame window software generates a buffer zone around the boundary data that normally has a predetermined shape such as a rectangle. The buffer zone has a size that is a certain percentage larger than the size of the circumscribed property so that a certain amount of surrounding land will be displayed in the images that are generated of the property of interest. The decisions regarding how to draw the frame window can operate in accordance with any desired algorithm. For example, if the width of the property of interest has a predetermined distance X, the distance from the outer most part of the property boundary to the frame window on either side may be selected as X/5, for example. The same process can be used in the vertical direction, i.e. the north and south direction, also. Again, any desired manner of selecting the size of a frame window can be used so that the frame window is automatically generated in a way that shows a certain percentage of surrounding property. At step 606, the buffer zone information is used to generate the frame window.

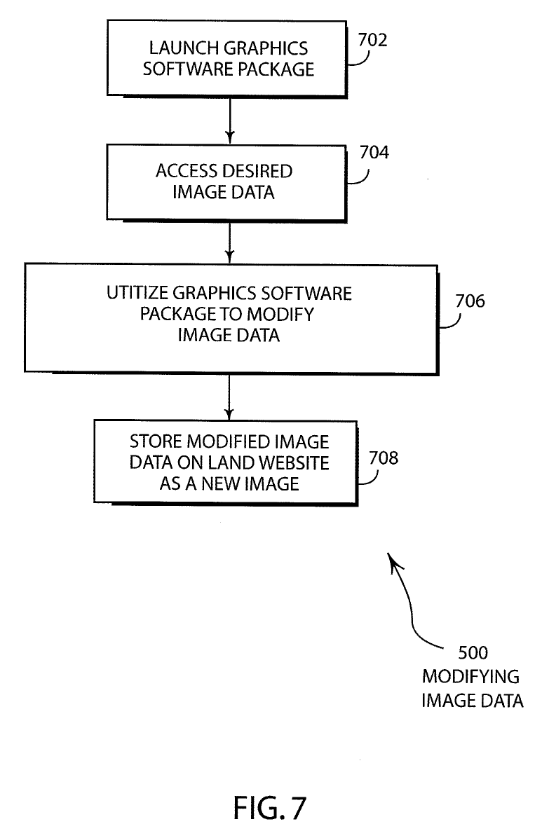

FIG. 7 illustrates the steps 700 that may be used in modifying image data. At step 502, any standard graphic software package can be launched by the user. Such graphic software packages may comprise Microsoft's PhotoShop, FotoAlbum available from FotoTime, or any other type of graphics package that is capable of displaying and modifying image data, such as jpeg image data. At step 704, the user accesses the desired image data using the graphic software package. For example, the user may wish to access and modify satellite image data or a USGS map to add or take out features. At step 706, the user employs a graphic software package to make modifications to the image data as desired. The graphic software package provides the ability to add or subtract features from the jpeg image. The image can then be stored as indicated at step 708 as a modified image on the land website or as a brand new image.

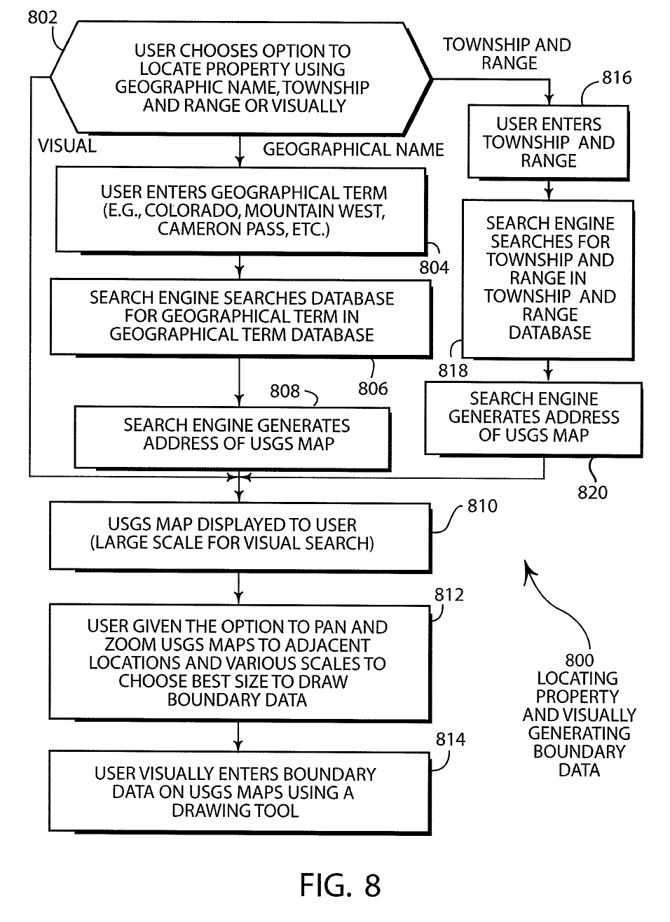

FIG. 8 is a flow diagram illustrating the steps 800 for locating property and visually generating boundary data. As shown in step 802, a user can choose the option of locating a property using a geographical name, a township or range, or visually locating the property using map data. If a geographical name is used, the process proceeds to step 804 where the user enters the geographical term. The geographical term can be a term such as the name of a state such as Colorado, a region such as Mountain West, a more specific geographical region such as Cameron Pass or Rawah Mountains, etc. There are approximately 1.6 million geographical names that are included in the GENIS (Geographical Name Information System) database that correspond to the USGS quad maps. By entering one of the geographical names from the GENIS database, a USGS quad map can be quickly accessed. At step 806, a search engine is employed that searches a database of geographical terms. The geographical terms are tied to a series of maps such as USGS maps so that the property USGS map can be located. Of course, any type of maps, such as BLM maps or other maps can be tied to the geographical term database. At step 808, the search engine generates an address for the USGS map or other map for the associated geographical term. At step 810, the USGS map or other map is displayed to the user that corresponds to the geographical term that has been used. At step 812, the user is given the option to pan and zoom the USGS maps or other maps to adjacent locations in various scales to choose the best size to draw boundary data. For example, the user may wish to use a 12 K map that shows more detail for smaller pieces of property rather than a 24 K USGS map since the 12 K maps show more detail. Additionally, since the points on each of the maps are georeferenced, smaller scale maps may be more desirable for carefully identifying boundary location points. The USGS maps or other maps can be joined together in a mosaic so that the user can pan from one location to another to locate the desired locations for drawing the boundary data. At step 814, the user visually enters the boundary data on the USGS maps using a drawing tool as described herein.

As shown in FIG. 8, the user may choose to enter a township and range to locate the property of interest at step 802. In this case, the process proceeds to step 816 where the user enters the township and range information. At step 818, a search engine searches for the township and range data in a township and range database. The township and range database is similar to the geographical term database in that it includes a large listing of township and range information which is tied to a series of maps such as USGS maps. Each township and range encompasses an area approximately 6 miles by 6 miles. Hence, a USGS map can be displayed that encompasses an area of approximately that size. Again, any type of map can be used. USGS maps are mentioned only for illustrative purposes. At step 820, the search engine generates an address for the USGS map. The process then proceeds to step 810 where the USGS map is displayed and proceeds through steps 812 and 814 as described above.

As further shown in FIG. 8, the user, at step 802, may choose to visually locate the property of interest. In this case, the process proceeds from step 802 directly to step 810 where a large-scale map is used to visually search. For example, a 1 million or 2 million scale map may be displayed which may show a large portion of a particular state. The user can then proceed through steps 812 and 814 to locate the property of interest. The zooming feature of the present invention simply switch scales of available maps and use processes for identifying the central portion of the particular map that is being displayed and aligning the central portion with a location on a map of a different scale with the central portions aligned. Alternatively, points can be located and clicked. Whenever the zoom-in or zoom-out button has been activated, the maps will change scale and locate the identified point in the central portion of the display.

The various ways of locating property, as illustrated in FIG. 8, can be very useful, especially when performing research on a particular area. For example, studying watersheds can be of particular interest since the watershed can be easily located using the methods described in FIG. 8, and a boundary area can be circumscribed around the area of interest. Further, the Forest Service or others may wish to locate an area and circumscribe that area for the purposes of studying and performing a controlled burn. Further, forestation and cutting of particular areas can be studied with a high degree of accuracy, especially in combination with actual satellite and vegetation images of the area of interest.

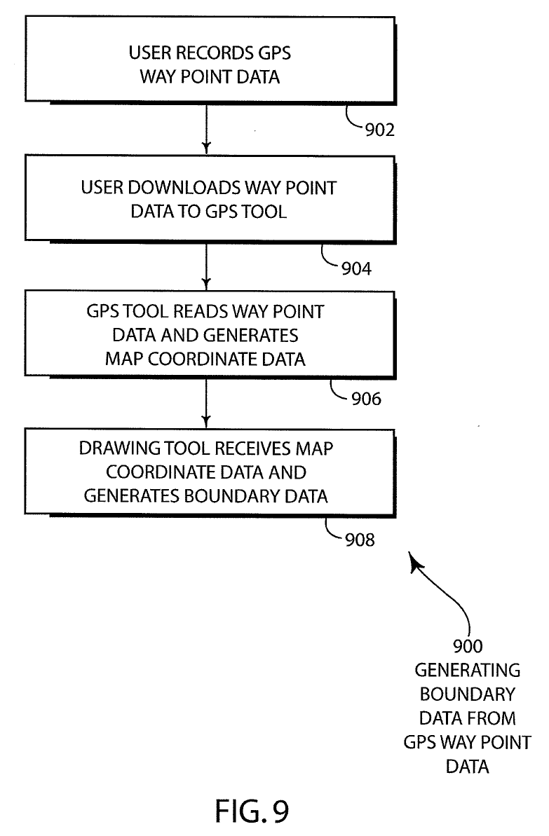

FIG. 9 is a flow diagram illustrating the steps 900 for generating boundary data from GPS way point data. In accordance with FIG. 9, a user may record GPS way point data by actually visiting the property. For example, a user may be a landowner who is visiting the property and has a portable handheld GPS device capable of recording way points. The user can record the way point data in accordance with a physical tour of the property to insure that the boundary locations are properly located. Similarly, Forest Service personnel may use a handheld GPS device to record way points for an area of interest for a particular study. Similarly, research personnel may wish to review a watershed area to make studies. In each of these cases, the individuals can record way points according to the actual physical locations of the user on the property. At step 904, the user can then download the way point data to a GPS tool. For example, handheld GPS devices can be interconnected to computer systems to allow the GPS way point data to be downloaded into the computer system. At step 906, the GPS tool then reads the way point data and generates map coordinate data. A translator program can be used to translate the GPS coordinate data to the USGS global coordinate system to locate the GPS way points on the USGS maps, for example. The map coordinate data can then be used by a drawing tool at step 908 to generate the boundary data that is used in accordance with the present invention.

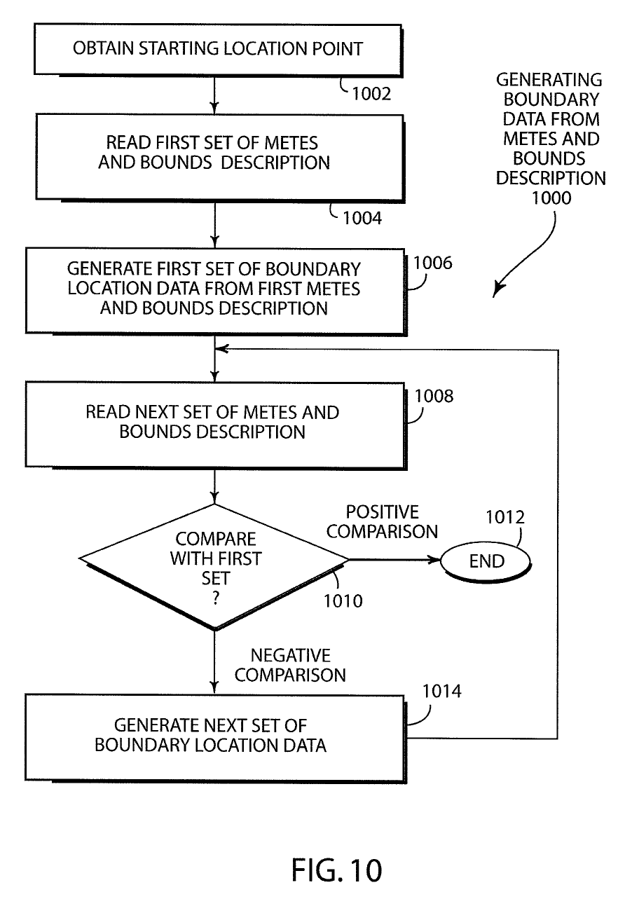

FIG. 10 is a flow diagram illustrating the steps 1000 for generating boundary data from metes and bounds descriptions. At step 1002, a starting location point is determined for the metes and bounds descriptions. This starting location point may be visually generated by a user on a USGS map or generated using a GPS way point, for example. Any desired method of generating a starting point can be used at step 1002. At step 1004, a metes and bounds tool reads the first step of metes and bounds description. The metes and bounds descriptions are generally given as vectors such as “proceed North Northwest for 475 feet.” Each of these metes and bounds descriptions can be entered into the system as separate vectors. Alternatively, this information can be read by the metes and bounds tool using character recognition techniques and separated using an indicator such as a semicolon for each vector description.

At step 1006, the metes and bounds tool generates a first set of boundary location data from the metes and bounds description. This is done by mathematically plotting each of the vectors onto the map data such as USGS maps to determine boundary location points. At step 1008, the next set of metes and bounds descriptions, i.e. the next metes and bounds vector, is read by the metes and bounds tool. At step 1010, a comparison is made to determine if the most recently read vector corresponds to the first vector. If it does, that indicates that all of the metes and bounds descriptions have been entered, and the process is ended. If it does not, the next set of boundary location data is generated at step 1014. The process then proceeds back to step 1008 until all of the metes and bounds descriptions have been read by the metes and bounds tool.

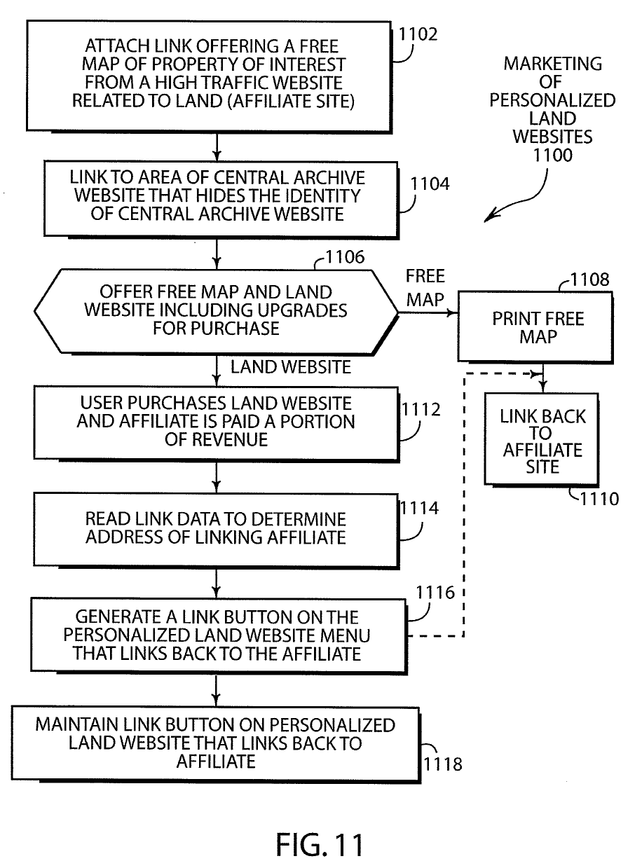

FIG. 11 is a flow diagram illustrating the steps 1100 that may be used in marketing personalized land websites. At step 1102, an affiliate is identified that has a high traffic website related to land. An agreement is entered into with the affiliate to attach a link from the affiliate's website offering a free map of land in accordance with step 1102. At step 1104, a link to an area of the central archive land website 102 (FIG. 1) is made that hides the identity of the central archive website. Since the identity of the central archive website of the present invention is kept hidden, the affiliate land website appears to be offering a free valuable service, i.e. a free map of land. In other words, the link button that appears on the affiliate's site that links to an area in the central archive land website that does not identify the central archive land website. In this fashion, it appears that the affiliate is offering the free map of the land. At step 1106, the user is then offered the option of obtaining the free map of the land or purchasing a land website including upgrades as disclosed elsewhere herein. If the user chooses a free map, the process proceeds to a step 1108 where a print of the free map is provided. At step 1110, the user is then linked back to the affiliate's site so that the affiliate has not lost this traffic. If the affiliate chooses to purchase a land website at step 1106, the process proceeds to a step 1112 where the user purchases the land website. At step 1114, the system reads the link data to determine the address of the linking affiliate. In other words, the central archive land website server 102 (FIG. 1) determines the address of the website from where the user has been linked. At step 1116, the central land website server automatically generates the land website for the user which includes a number of menu items. One of the menu items is a link button that links back to the affiliate's site. For example, if the affiliate's site is a lender that specializes in lending money for purchase of ranches, a link button will be provided directly back to that lender. At step 1118, the link button is maintained on the personalized land website that links back to the affiliate for as long as the website remains active. After the land website is generated, the user may be linked directly back to the affiliate's site as shown at step 1110.

The process disclosed in FIG. 11, in this manner, allows the affiliate to offer a valuable free service to the users of the affiliate's site by offering the free map while still having these users linked back to the affiliate's site. In addition, if a user purchases a land website, the affiliate obtains a portion of the revenue of the land website by an agreement between the affiliate and the central land website owner. Further, a link is maintained, that cannot be removed by the user, on the personalized land website back to the affiliate for the entire time that the website is active. By using such a marketing scheme, agreements with affiliates can be easily established.

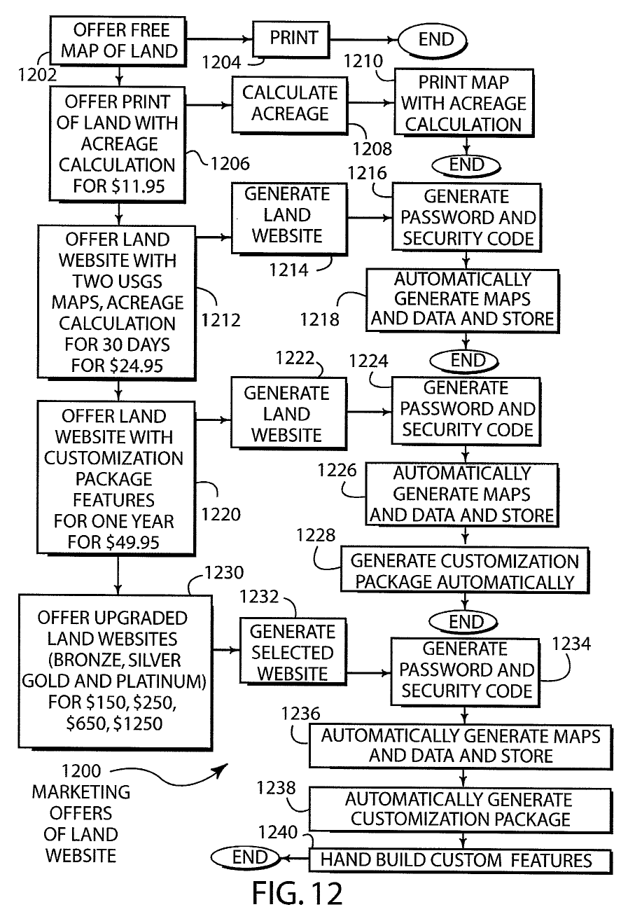

FIG. 12 is a flow diagram illustrating the steps 1200 in marketing offers of land websites and land website services. FIG. 12 graphically illustrates the manner in which various upgraded services and products can be provided to users at progressively higher prices. Each of the prices illustrated in FIG. 12 is for illustrative purposes only and are provided to indicate the types and services of products that may be available at various illustrative prices. At step 1202, a user is initially offered a free map of the land. If the user chooses the free map, the map is printed for free at step 1204 and the process ends. At step 1206, the user is offered a print of the land together with an acreage calculation for an exemplary price of $11.95. If the user chooses this option, the acreage of the circumscribed property is calculated at step 1208, and a map is printed with the acreage calculation at step 1210. The process is then ended. At step 1212, the user may be offered a land website with two USGS maps and an acreage calculation for a period of 30 days, for example, for an exemplary price of $24.95. If the user selects this option, a land website is generated at step 1214. At step 1216, a password and security code are generated for the user which allows the user to access the land website. At step 1218, maps and data are automatically generated and stored. The process is then ended. At step 1220, the user may be offered a land website with a customization package for a period of one year for a price of $49.95, for example. The system then generates a land website at step 1222, and a password and security code are generated at step 1224. At step 1226, maps and data are automatically generated and stored. At step 1228, a customization package is automatically generated, and the process ends. The customization package can then be used by the user for generating various features of the land website that are described herein. At step 1230, the user may be offered an upgraded land website such as a bronze, silver, gold or platinum level website for exemplary prices of $150.00, $250.00, $650.00 or $1250.00, for example. At step 1232, the selected type of land website is generated. At step 1234, a password and security code are generated. At step 1236, maps and data are automatically generated and stored. At step 1238, a customization package is automatically generated, as described herein. At step 1240, custom features may be hand built into the system such as fly-around movies, 3-D satellite imagery and other custom features.

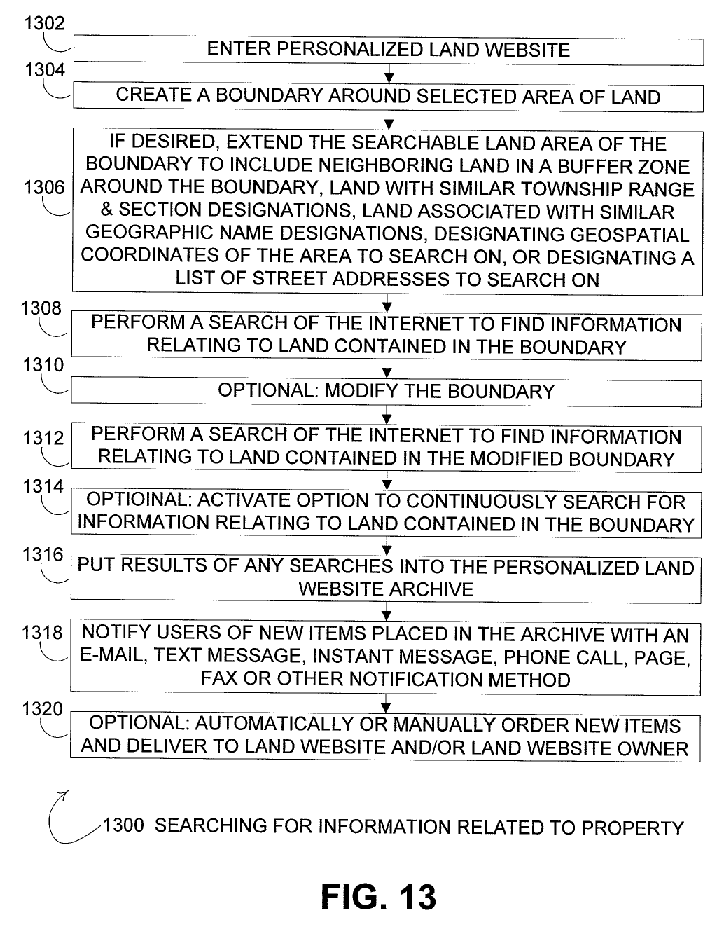

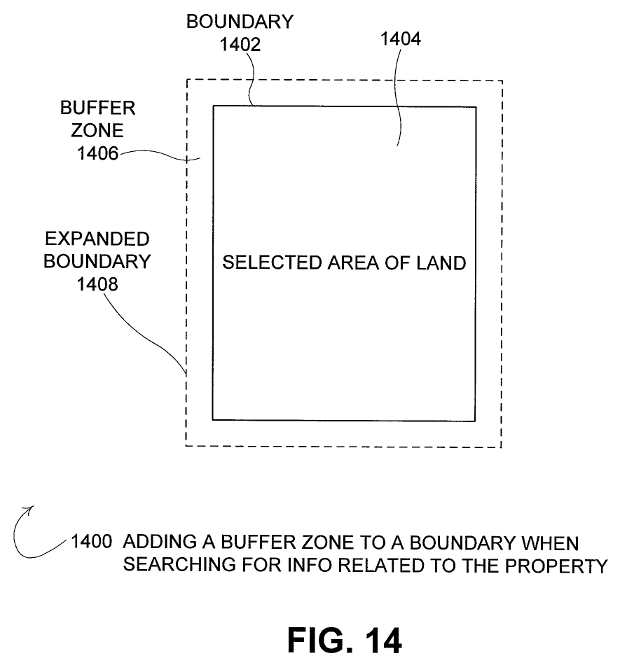

FIG. 13 is a flow diagram 1300 illustrating the steps for searching for information related to a selected area of land on the Internet. Before searching for information on a property, a user must first enter the personalized land website 1302 and create a boundary around, or partially around, a selected area of land 1304. The personalized land website and the associated boundary around or partially around the selected area of land may be automatically created from information contained in a database or other electronic files as well as by scanning an image containing boundaries and transposing those values onto an electronic map. In some instances a single geospatial coordinate point (e.g., latitude and longitude) may define a boundary. A boundary may also be defined by a range of geospatial coordinate points that may define a line or a shape. The shape defined by the range of geospatial points may be a regular geometric shape such as a circle, ellipse, rectangle, triangle or the like. The shape defined by the range of geospatial points may also be an irregular shape that does not fit any standard geometric shape. If desired, the user may extend the searchable area of the boundary 1306 to search for additional information on the selected area of land, neighboring properties, and other related properties. In order to include immediately neighboring properties in a search for additional information, the boundary may be extended to include a buffer zone extending the boundary outward by a percentage or a fixed distance. Using a buffer zone to extend the boundary is discussed in more detail in the disclosure with respect to FIG. 14. Related properties to include in a search for additional information may include properties with similar township range and section designations as the selected area of land. Related properties may also include properties that reference the same geographic names as the selected area of land. Geographic names may be obtained from the list of geographic names included in USGS quad maps as well as other sources containing geographic names. Related properties may also include all properties in an area defined by geospatial coordinates designated by a user. The geospatial coordinates may be latitude/longitude points defining the corners of an area to search that is different than the border defining the selected area of land of the personalized land website. The geospatial coordinates may define an area much larger or just different than the selected area of land of the personalized land website that matches the searching criteria of a personalized land website user. Related properties may further include a list of designated street addresses.

After the boundary is created 1304 and possibly extended 1306, an embodiment may perform a search of the Internet to find information relating to the land contained in the boundary 1308. The additional information searched for may include various map data illustrating the boundaries of the property, satellite image data, photographic data, third party maps, e-documents (text material) relating to the property such as legal descriptions, leases, surveys, grazing leases, title abstracts, title and deed information, public land leases, easements and rights-of-way, watershed studies, other studies, loan information, appraisal reports, insurance, conservation easements, ownership rights, mineral rights of land, water rights of land, land titles, environmental audit, insurance documents, improvements, leases, flood plain data, scanned documents, loan documents, e-appraisal reports, and other similar e-document information. Additionally, data may include links to live information and/or third party data only available from a third party website. For instance links to webcams for viewing the land, links to video streaming for viewing the land, links to blog websites, links to RSS feeds, links to podcasts, and links to other resources that display data obtained from sources other than the land website may also be contained in the additional data stored in the archive. An RSS feed refers to a family of technology specifications used to publish frequently updated material. RSS may variously be used to represent Really Simple Syndication, Rich Site Summary, and/or RDF (Resource Description Framework) Site Summary. Third party maps may be stored by the user on the personalized land website, as well as image data that has been modified by the user. In short, any type of information relating to the land may be stored by the user on the personalized land website.

At step 1310, the user may modify the boundary if desired. The modified boundary may be permanently saved on the land website. After the boundary is modified, an embodiment may perform another search on the Internet 1312 to find information related to the land contained in the modified boundary. If desired, the user may activate an option to continuously search the Internet for information related to the land contained in the boundary 1314. The continuous search may be performed by Internet robot software. Internet robot software may also be called by a variety of different names including bot, spider, and crawler software. The results of all searches for additional information on a property may be placed in the archive of the personalized land website for the boundary 1316. All searches may be performed on the land contained in the boundary or the land contained in the boundary plus the extended searchable area as described herein. If new information relating to the selected area of land is found, an embodiment may notify a land website user with an e-mail, text message, instant message, phone call, page, facsimile (Fax), or any other notification method 1318. If new items of information are found, the user may optionally order the new items of information for inclusion in the land website and/or to be sent to the user directly 1320. The user may manually order the new information items by selecting the items and ordering the items or the user may configure the system to automatically order new items when the new items become available.

FIG. 14 is a diagram 1400 that illustrates the expansion of a boundary 1402 via a buffer zone 1406 used for searching for information on a selected area of land that also includes neighboring properties contained in the buffer zone 1406. One embodiment may extend the searchable area of land for an Internet search for additional information related to the land by adding a buffer zone 1406 to the selected area of land 1404. In order to obtain the buffer zone 1406 the original boundary 1402 is expanded to the extents of an expanded boundary 1408. The area between the expanded boundary 1408 and the original boundary 1402 is the buffer zone 1406. The expanded boundary 1408 may be sized as a percentage of the original boundary (e.g., 110% of the original boundary). The expanded boundary area 1408 may also be sized by extending the boundary by a fixed length measurement (e.g., extend the boundary by 10 feet on all sides).

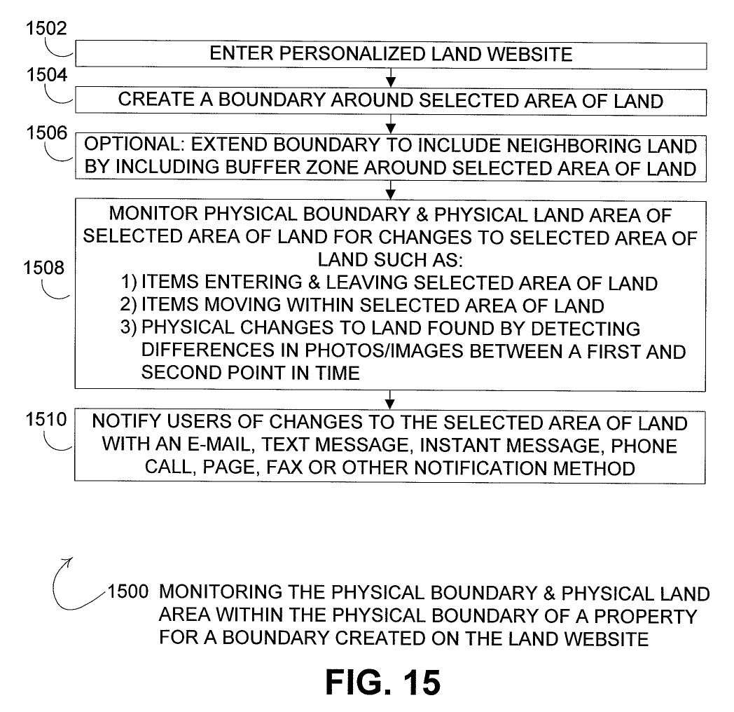

FIG. 15 is a flow diagram 1500 illustrating the steps for monitoring the physical boundary and physical land area within the physical boundary of a property for a boundary created on the land website. Before monitoring the physical boundary and/or the physical area within the boundary of a property, a user must first enter the personalized land website 1502 and create a boundary around, or partially around, a selected area of land 1504. In order to include immediately neighboring properties in a search for additional information, the boundary may optionally be extended to include a buffer zone extending the boundary outward by a percentage or a fixed distance 1506. The buffer zone would operate in the same fashion as the buffer zone disclosed with respect to FIG. 14. With the boundary created, the land website may act as the management interface for a system that monitors the selected area of land 1508. The monitoring system may monitor the selected area of land variety of changes 1508.

The monitoring system may monitor the physical boundary to detect an item entering or leaving the selected area of land 1508. The physical boundary of the land corresponds to the boundary drawn on the map in the land website. The monitoring system may further monitor the physical land area within the physical boundary to detect movement of items within the selected area of land 1508. A number of systems may be used to monitor the physical boundary and/or the physical land area within the physical boundary, such as: monitoring the physical boundary and the physical land area of the selected area of land to detect the changes to the selected area of land comprises at least one of the group consisting of: satellite surveillance of the physical boundary and within the physical land area of the selected area of land; analyzing satellite and aerial photographs and images of the selected area of land; motion detectors installed along the boundary and within the physical land area of the selected area of land; detection of Radio Frequency Identification (RFID) devices at the boundaries and within the physical land area the selected area of land; Global Positioning System (GPS) devices with communications capabilities tracked on the physical border and within the physical land area of the selected area of land, video surveillance of the boundary and within the physical land area of the selected area of land; and webcam surveillance of the boundary and within the physical land area of the selected area of land. A smart system may be employed to detect movement of items based on satellite surveillance delivered to a computer system. Similarly, a webcam or video surveillance system may be employed with a smart system to monitor and detect movement of items across the physical boundaries of the property. RFID devices may be employed to track specific items as they cross the physical boundary of the property. An RFID chip will need to be placed on all items that a user desires to track. GPS devices may be loaded with the boundary coordinates of the selected area of land and programmed to communicate to the land website any time the GPS device enters or leaves the physical boundaries of the property. Motion detectors may also be employed to sense the movement of items over the physical boundaries of the property. If an item has been detected entering or leaving the property, the land website may notify an interested party with an e-mail, text message, phone call, page, facsimile (Fax), or any other notification method. The monitoring system may also monitor the selected area of land for structural changes 1508 such as new buildings, roads, other manmade structures, water bodies, forests, or other geographic features. Similarly, the system may monitor for removal of the same types of structural features as well. To monitor for structural changes to the selected area of land, the system may obtain images of the selected area of land, typically satellite or aerial images, at a first time and similar images at a second time. The system would then compare the images taken at the first time against the images taken at the second time and analyze the differences to determine if any significant structural changes have taken place on the selected area of land between the first time and the second time. If any changes are detected by the monitoring system, the monitoring system may be configured to notify users the detected changes to the selected area of land 1510. Some notification methods include, but are not limited to: e-mail, test message, instant message, phone call, page, facsimile, or other notification methods.

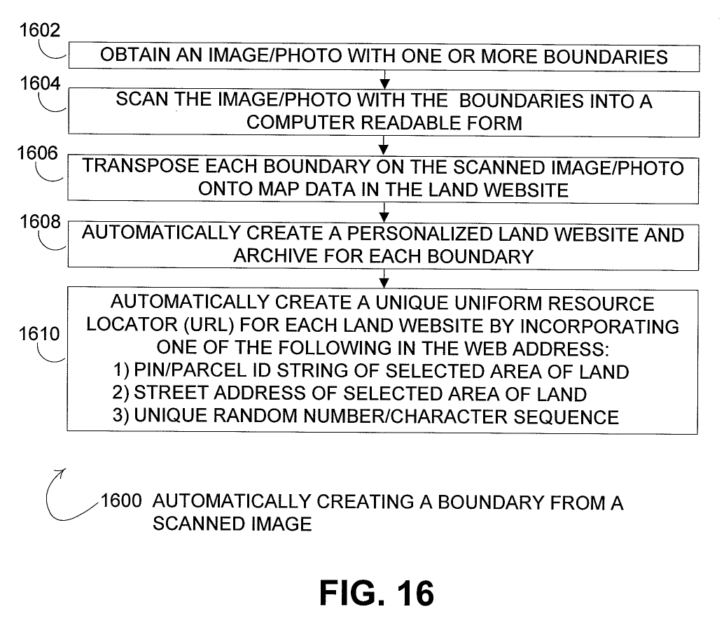

FIG. 16 is a flow diagram 1600 illustrating the steps for automatically creating a boundary on the land website from a boundary contained on a scanned image or photograph. The boundary drawing tool may automatically create boundaries from boundaries drawn on a map or image. At step 1602 of FIG. 16, the user obtains an image or photograph that shows one or more property boundaries. The image or photograph may be another map containing the boundary. The image or photograph with the boundaries is then scanned into computer readable form 1604. The boundary drawing tool then analyzes the scanned image/photograph and transposes each boundary contained in the scanned image/photograph onto the map data of the land website 1606. At step 1608, a personalized land website and archive is created for each boundary transposed onto the land website map data in step 1606. At step 1610 a unique Uniform Resource Locator (URL) is automatically created for each personalized land website created in step 1608. A URL is also known as a web address. To ensure that a unique URL is created, various embodiments may incorporate some unique descriptor of the selected area of land, such as a Parcel Identification (PIN) number/string of the selected area of land or a string representing a street address of the selected area of land. Embodiments may also use a random number/string generator to create a unique, random number/string to include in the URL for a personalized land website. Various embodiments may include the unique number/string at various locations in the URL, ranging from the host name identifier to the path to the actual file name.

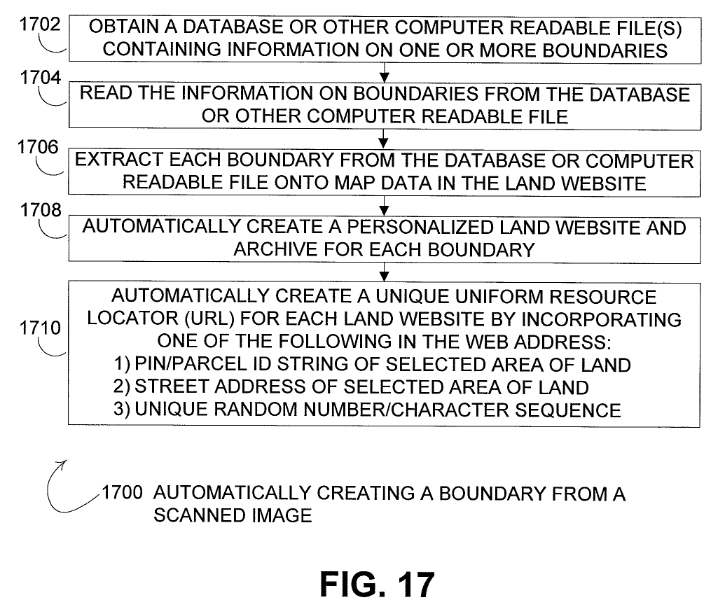

FIG. 17 is a flow diagram 1700 illustrating the steps for automatically creating a boundary on the land website from boundary information contained in a database or other computer readable file. The boundary drawing tool may automatically create boundaries from boundary information contained in a database or other computer readable file. At step 1702, the user obtains a database or other computer readable file containing information on one or more boundaries. The boundary drawing tool then reads the boundary information from the database or other computer readable file 1704. The electronic file may contain many types of boundary information. For instance, an embodiment may use a vector database defining the border using vector definitions. Another embodiment may use a database or spreadsheet that includes the geospatial coordinates of the boundary corners. Still another embodiment may include street addresses and/or Parcel Identification (PIN) numbers along with a single geospatial coordinate point. The single geospatial coordinate point then acts as the boundary partially enclosing the selected land area. Various embodiments may utilize multiple files containing a variety of information on each selected area of land. At step 1706, the boundary drawing tool extracts each boundary from the database or computer readable file onto the map data in the land website. At step 1708, a personalized land website and archive is created for each boundary extracted onto the land website map data in step 1706. At step 1710 a unique Uniform Resource Locator (URL) is automatically created for each personalized land website created in step 1608. A URL is also known as a web address. To ensure that a unique URL is created, various embodiments may incorporate some unique descriptor of the selected area of land, such as a Parcel Identification (PIN) number/string of the selected area of land or a string representing a street address of the selected area of land. The PIN and/or street address may be contained in the database or other electronic files containing the boundary information. Embodiments may also use a random number/string generator to create a unique, random number/string to include in the URL for a personalized land website. Various embodiments may include the unique number/string at various locations in the URL, ranging from the host name identifier to the path to the actual file name.

Some embodiments may permit multiple boundaries to be treated as a single boundary when one or more of certain attributes associated with each of the multiple boundaries matches between the multiple boundaries. For instance, two separate boundaries found with the same street address may be treated as a single boundary. In order to treat the multiple boundaries as a single boundary, the system may merge the two boundaries into a single boundary. Alternatively, the system may include each of the boundaries in a single personalized land website and perform all functions, such as searching and monitoring, on the multiple boundaries as if the boundaries were a single boundary. Any attribute associated with a boundary or the selected area of land defined by a boundary may be considered as a potential matching boundary. In some embodiments, the system may require a combination of attributes to match before determining that multiple boundaries are matching boundaries. Some possible attributes include, but are not limited to: owner, co-owner, mailing address, property name, geographical feature, postal code, city name, geospatial coordinates, metes and bounds description, and township range and section of the multiple selected areas of land defined by the multiple boundaries.

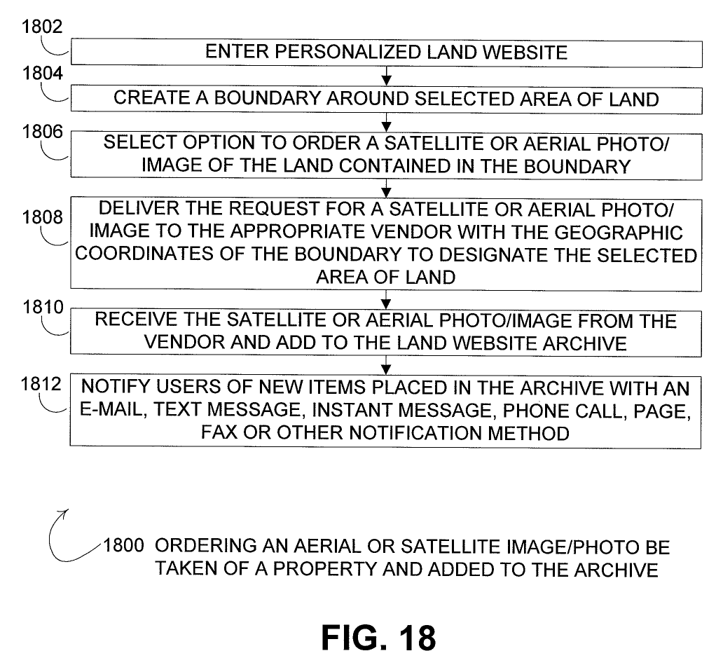

FIG. 18 is a flow diagram 1800 illustrating the steps for ordering an aerial or satellite image or photograph of a selected area of land and adding the image or photograph to the personalized land website archive for the selected area of land. Before ordering an aerial or satellite image, a user must first enter the personalized land website 1802 and create a boundary around, or partially around, a selected area of land 1804. After the boundary is created, the user may select an option to order a satellite or aerial image/photograph of the land contained in the boundary 1806. At step 1808, the land website delivers the request for a satellite or aerial image/photograph to the appropriate vendor. The land website automatically includes the geographic coordinates of the boundary of the selected area of land with the request for the aerial or satellite image/photograph. At step 1810, the land website receives the aerial or satellite image/photograph of the selected area of land and adds the image/photograph to the land website archive. When new photographs or images are added to the archive or ready for deliver the personalized land website may be configured to notify users of the new photographs or images of the selected area of land 1812. Some notification methods include, but are not limited to: e-mail, test message, instant message, phone call, page, facsimile, or other notification methods.

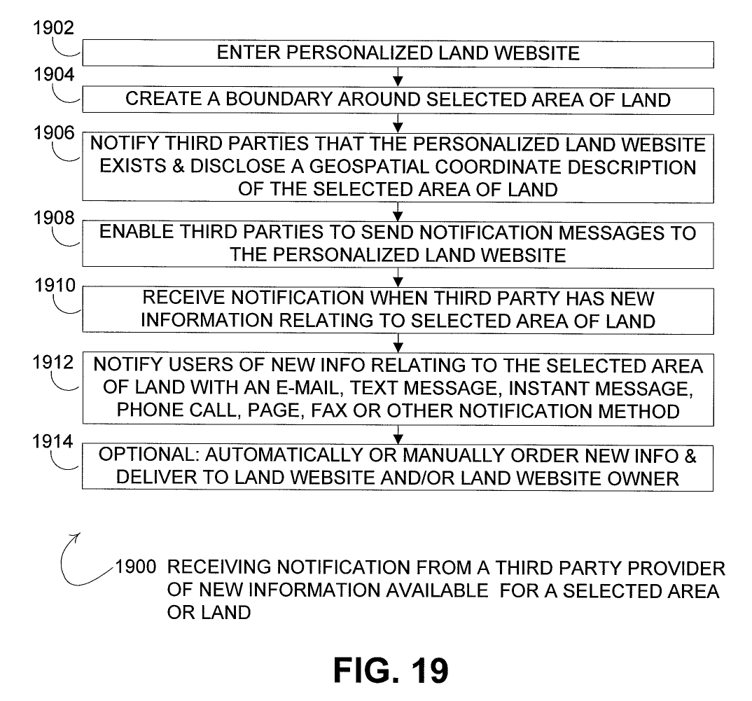

FIG. 19 is a flow diagram 1900 illustrating the steps for a land website to receive notification from a third party provider of new information available for a selected area of land. To begin, a user enters a personalized land website 1902 and creates a boundary around a selected area of land 1904. The personalized land website then notifies one or more third parties that the personalized land website exists and discloses a geospatial coordinate description of the selected area of land to the third parties 1906. The personalized land website then enables the third parties to send notification messages to the personalized land website 1908. The personalized land website receives the notifications from a third party when the third party has new information that relates to the selected area of land 1910. When the personalized land website has been notified of new information relating to the selected area of land, the personalized land website may be configured to notify users of the new information related to the selected area of land 1912. Some notification methods include, but are not limited to: e-mail, test message, instant message, phone call, page, facsimile, or other notification methods. At step 1914, the personalized land website may optionally order the new information relating to the selected area of land from the third party 1914. The new information may be delivered to the personalized land website and/or to an owner/user of the personalized land website. Ordering the new information may be done manually by the user or the personalized land website may be configured to automatically order new information when new information becomes available.

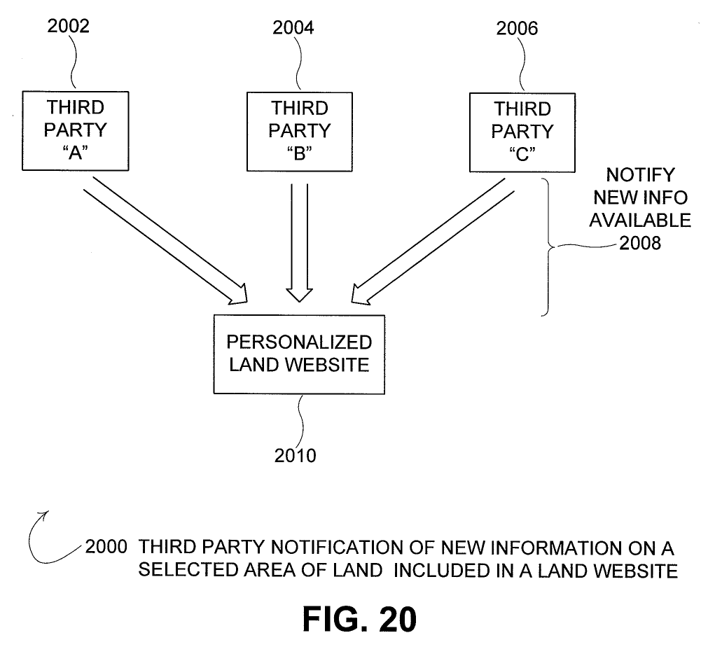

FIG. 20 is a schematic illustration 2000 of third party notification of new information on a selected area of land included in a land website. A third party 2002, 2004, 2006 may be configured to notify 2008 the personalized land website 2010 when new information becomes available. In this way third party “A” 2002, third party “B” 2004, and/or third party “C” can proactively notify 2008 the personalized land website 2010 when new information relating to a selected area of land is available rather than waiting for the personalized land website 2010 to search for and locate the new information.

Various embodiments therefore provide a unique system for providing individualized land websites that allow data and images regarding a particular piece of property to be collected in a single, easily accessible location. By gathering information in a single location, the time required to purchase or sell property can be accelerated since the information is easily and readily available to everyone involved in the process of a sales transaction including brokers, lenders, appraisers and owners. The land website can also be used to store this important information after the sale and provide an ongoing historical record of the property that includes actual images and condition of the property. The land website can be used for planning and development purposes, such as deciding the best way to subdivide a property, meet environmental regulations, provide crop and/or livestock management, plan development of the property such as introduction of canals or ponds, forestation and cutting of forests, as well as various other purposes. The land website can be accessed by anyone having the password and security code, such as government officials making decisions relating to the property. Further, the land website allows users to e-mail images of the property if the user does not wish a particular individual to have full access to the personalized land website. Further, since the map data and image data is presented in an image format, standard graphics packages can be used to modify the images and easily indicate any desired features for planning purposes, or any other informational purposes.

Various embodiments utilize simple web browsers that are available on most personal computers to access and view the images of the property and also uses standard graphics packages to make modifications. Hence, the land website is intuitive and easy to use. Easily accessible image format data can be provided in a secure manner to users. The land website of the present invention provides a useful and unique tool for utilizing both satellite image data and map image data, as well as other associated data relating to a piece of property, in a simple and easy fashion. Further, boundary information can be easily generated by either selecting a global coordinate location such as a township and range, or by simply accessing a location on a map and enlarging the view to an appropriate size so that boundaries can be drawn using a simple and easy-to-use boundary applet tool. Boundary information may also be automatically generated by reading a database or other computer readable file for boundary information and/or scanning a map or image that contains boundary information and transposing the boundary information onto the map data. Further, the present invention is also capable of providing unique 3-D images and 3-D fly-around movies of the property so that a virtual tour can be taken of the property. The virtual tour images can be created using composites of various satellite image data as well as map image data to provide a very complete and authentic view of the property. For example, infrared vegetation imaging can be combined with regular visual image data from satellites to provide a very realistic view of the property. Further, USGS map data or BLM map data may be included in the image to show legal boundaries and various features of the property. In this way, individuals, such as lenders and appraisers, can view the property in a very realistic fashion without actually taking the time to visit the property. In this manner, valuable time and effort can be saved by using the land website of the present invention.

Some advantages of various embodiments are that digital images including map data can be provided in a simple and easy fashion over the Internet that allows users to circumscribe the boundaries of a piece of property of interest. A unique personalized, customizable website for the property of interest (land website) can then be established that allows viewers having a password to view the property and related information relating to the property. Various image data can be viewed in various desired combinations that allows a viewer to take virtual tours of property over the Internet by accessing land websites of ranches, farms, land areas of interest and other large properties in an affordable manner. Updates can be easily made to the land website. The Internet may be searched to locate new information relating to the land and the new information may be added to the land website archive. Purchase of new information that has become available such as flood plain data, new maps, etc. can be made by a user in response to e-mail notifications. The user may also initiate the creation of new information by using the land website to request that a new aerial or satellite image be taken of the land. In other embodiments, a third party may notify the personalized land website that new information on a selected area of land is available.

When using various embodiments for land marketing purposes, the time between listing and closing on the sale of the property can be reduced by having a land specific web site that allows users to take virtual tours. For example, research time is reduced because paper maps that cover the appropriate area do not have to be located and purchased. The land website and virtual tours that are established in accordance with the present invention do not require technical skills of the user to establish a land website. For example, a landowner who wishes to use this service can easily do so by circumscribing that property using a simple boundary generation software drawing tool that may be provided over the Internet with the map image data. The system disclosed in various embodiments is intuitive and easy to use. One of the features of the present invention that aids the user in establishing a boundary is the establishment of georeferenced points on a plurality of different types of maps that cross-link information from one map to another to aid the user in identifying boundary points. The land website can be made publicly available for marketing purposes.

Further, various embodiments do not require the user to obtain special software. Commonly available web browser software such as Internet Explorer, Netscape, etc. can be used to access the land specific websites. Graphics packages such as Microsoft Paint, Adobe Photoshop and other commonly used image modifying software are also readily available which allow a user to generate modified image data. The disclosed embodiments have the convenience of being available to any computer having Internet access, at any time, from any location.

A further advantage of various disclosed embodiments is that information relating to the property can be located in one convenient place, i.e. the land website. Customization modules allow users to add scanned and text documents, appraisals, reports, loan documents, photographs, third party maps and other information relating to the property. For example, using a customization module, which may part of an upgrade package, a user can change the web page style. If the user is attempting to sell a cattle ranch, the web page may display cattle and cowboys. If the property is somewhat mountainous with streams, the user may wish to have a web page that shows fly fishing. Further, a customization module may allow the user to upload photos to a photo gallery that is part of the web page. Also, the customization module may have a location for storing e-documents. For example, PDF documents relating to legal descriptions, easements, watershed studies, other studies, forestation, etc. may be scanned and stored in the e-document section. The e-document section may have multiple passwords for limited access. The documents can be stored in any desired format such as PDF format, Word, WordPerfect, jpeg images, etc. The customization module may also allow the user to add links to other locations. For example, if a question arises regarding a particular easement or right of way, a link to a particular treatise on easements and rights of way may be established by the user through the land library. Further, the customization module may allow the user to modify standard images such as jpeg images using available graphics software packages such as Microsoft Paint, and reload those modified images onto the website. Further, the customization model may allow the user to load third party maps onto the land website. Other information such as ideas, directions to the property, etc. can also be stored on the land website.

A further advantage of at least one embodiment is the ability to provide a comprehensive system of storing map data and other data in a simple and easy fashion. For example, a specific implementation of the present invention will allow up to 35 different maps of the property to be stored in a single accessible location including 3-D satellite photography, general vicinity maps, regional and statewide maps and photography, 1:24 K USGS maps, quad maps, 1:100 K quad maps, 1:250 K USGS maps, BLM maps, 2.50 D maps (e.g. color variations to show elevation differences), 3D maps, and/or any other types of maps, in a single accessible location. The user can easily customize any of these maps that are presented as image data using standard graphic software. In addition, modified satellite imagery provided in accordance with the disclosed embodiments allows an elevated 360 degree fly-around view of the subject property showing topological features and boundaries of the property.

Another advantage of the various disclosed embodiments is that the boundary information can be cross-linked to satellite imagery in the same manner that various types of maps such as USGS, BLM and other types of maps are crossed linked. In this fashion, a particular location or land mass can be positively identified on any desired type of map such as a BLM map, USGS map or other type of map and the corresponding satellite imagery can be displayed with the boundary information by georeferencing the boundary information to global coordinates on the satellite image data. Typically, it is difficult to identify particular locations on satellite imagery because of the lack of political boundaries, legends and other features that are normally shown on typical maps. The georeferencing of global coordinates allows the user to clearly identify specific locations on satellite imagery with an assurance of correctness that has not previously been available, especially for neophyte viewers of satellite data. In this fashion, satellite imagery can now be easily provided through Internet connections that allow the user to view specific areas of interest.

The disclosed embodiments may also assist brokers in marketing their services. For example, brokers that can offer property for sale using the land websites of the present invention are more likely to obtain sales. Brokers can purchase lower cost implementations to demonstrate the properties and features of the land website to a potential seller to obtain a listing. For example, at least one embodiment may be implemented in a fashion that allows a broker to establish a land website for a particular piece of property that includes only several inexpensive maps. The land website can then be upgraded to provide land virtual tour components such as 3-D maps, fly-around views and other more expensive features after the listing has been obtained. In addition, any particular virtual tour or other image data can be directly e-mailed to potential buyers, brokers, lenders, appraisers and/or engineers and others utilizing the system of the present invention. Also, since the map information is generated as image data, the image data can be used to generate hard copy images such as sales brochures, wall maps and other materials.

Various embodiments also have the advantage of saving time and minimizing effort in sales activities. For example, buyers can take a virtual tour of the property which may speed the buyer's interest or quickly eliminate uninterested buyers. This may save a considerable amount of time by eliminating physical tours by the broker with uninterested buyers. Instantaneous access and the ability to e-mail image data and virtual tours also saves broker time. Brokers who have individual websites can provide links to the land websites for each of the properties listed by that broker which provides a simple way to concentrate sales of property listed by that broker.

Various embodiments may also speed the due diligence process of a land buyer. For example, appraisals and loan commitments can be obtained in a much quicker fashion utilizing the present invention. E-mail links can be provided to various information located within the land website which provides all of the base information needed for appraisers and lenders including legal documentation, legal descriptions, printable maps and images, land boundaries, improvements and other information.

Various embodiments may also be used for purposes other than the sale of real estate, such as management, research, conservation easement creation and maintenance of real estate. Further, the land websites of various embodiments can be used for studying property and as a decision making tool. For example, a landowner, manager and consultant of the property can all log onto the land website and make decisions regarding items such as grazing management, fencing and other improvements such as road construction, placement of ponds and lakes, etc. Further, subdivision decisions and other planning decisions can be made using the easily accessible land websites of the present invention. More specifically, map and satellite information is provided as image data, such as jpeg image data, that can be modified by a user and restored on the land website for discussion purposes with land managers, county and state officials, etc. Watershed management, forestation, selective cutting, crop maintenance and other similar uses can be made of the land website of the present invention. Various embodiments utilize simple web browser technology and graphic image display software that is commonly available and allows users to modify and enhance images and upload them for functionality and convenient access and retrieval of the land website. Another purpose may utilize the boundary generated on the land website to monitor the physical boundaries of the property corresponding to the land website boundary for items entering and/or leaving the designated property. The physical land area within the physical boundaries of the selected area of land may also be monitored for items moving within the boundaries as well as for changes to physical structures of and on the selected area of land. Items monitored may include, but is not limited to: people, animals, vehicles, cargo, and other items that a user may desire to track.

Various embodiments may also employ a unique marketing approach. In accordance with the marketing approach of the present invention, third party websites relating to land that may have a large amount of traffic are provided with a link button that offers a free map that links directly to the land website of various embodiments. The point at which the user is linked to the land website may be an internal point within the land website of various embodiments that does not provide overt identification of the land website. The viewer of the third party website can then print a free detailed map of the land or land area of interest that displays the boundaries drawn by the user. As the user proceeds to print a free map, a purchase option is presented to the user to purchase a land website. If a land website is actually purchased by the user, a referral fee can then be paid to the referring website. Traffic can then be driven back to the referring website for other purposes. In this fashion, the link to the land website does not cause traffic to be permanently diverted or lost by the referring website. For example, if a land website is purchased, the traffic may be redirected to the referring website to obtain a loan for the property or place an order to buy future products and services from the referring website. The land website portal may also be accessed by a large tree of domain names that have geographically descriptive terms in combination with generic terms relating to land such as disclosed in U.S. Provisional Patent Application Ser. No. 60/288,815 filed May 4, 2001 entitled “A System for Selling Real Estate Products and Services Through the Internet” by Craig Harrison, which is specifically incorporated herein by reference for all that it discloses and teaches.

Various embodiments also provide various ways of locating a desired piece of property. In one embodiment, geographic names can be used from the USGS quad maps to narrow in on a desired piece of property. In another embodiment, a search can be performed using township and range identifiers to locate a piece of property within a 6 mile by 6 mile boundary. In a further embodiment, the property can actually be visually located on maps using various maps having different scales to zoom in on the property location. The geographic names and township range and section data may also be used to search for additional information on neighboring properties and/or properties related to the desired property.

Further, various techniques can be used for plotting boundaries. For example, points can be visually located on maps and image data to locate boundary points. Further, metes and bounds descriptions can be entered into the system which automatically plot the boundaries using mathematical calculators. As long as the initial point can be located properly, such as through a visual location or other global coordinate system, the metes and bounds description can be plotted using a metes and bounds drawing tool. A third way of plotting boundaries is to use GPS way points that have physically been recorded during a visit to the property. These GPS way points are then loaded into a GPS boundary mapping tool that plots the boundaries on a map that aligns the GPS locations with the proper locations on the map. Boundaries are then formed according to those locations. To automatically generate boundary points, one embodiment may scan an image containing a boundary, analyzed the scanned image, and transpose the boundary onto the map data. Another means to automatically generate boundary points may cause an embodiment to read boundary data from a database or other computer readable file and place the boundary data on the map data of the personalized land website. Boundary data may also be interpreted and created on the fly if the boundary data in the electronic file must be interpreted and manipulated in order to create the boundary for a selected area of land. Alternatively, if the drawing tool is used to generate the boundary data, latitude and longitude coordinates can be recorded as the cursor is moved along the boundary. In this manner, the boundary that is drawn by the user can be recorded using latitudinal and longitudinal data points (boundary data) for comparison with actual property descriptions. In addition, the drawing tool can also provide bearing, distance and direction information as the cursor is moved along the boundary line. In this fashion, the user can plot boundaries by hand using the drawing tool and provide accurate boundaries using metes and bounds descriptions. If a particular metes and bounds description includes a latitude and longitudinal location for any of the corner points, that point can be used as a starting point and located exactly on the map since the map includes the global positioning data. Further, if GPS way points are used, the GPS boundary mapping tool may automatically select the correct size map and satellite resolution to display the property.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of generating a personalized land website at an Internet accessible location on the Internet, said personalized land website providing an archive of a variety of information relating to a selected area of land comprising:
creating said Internet accessible location of said personalized land website for storage of said archive of said variety of information;
providing map data over the Internet that relates to said selected area of land;
providing boundary drawing tools to allow a boundary to be circumscribed at least partially around said selected area of land on said map data;
drawing a boundary at least partially around said selected area of land using said boundary drawing tools;
storing said map data as part of said personalized land website; and
providing additional storage locations as part of said personalized land website for storage of additional information relating to said area of land.

2. The method of claim 1 wherein said boundary is comprised of a single geographic point partially enclosing said selected area of land to define said selected area of land.

3. The method of claim 1 further comprising:
extending said selected area of land to include related land of said selected area of land; and
performing personalized land website operations on said selected area of land extended to include said related land instead of performing said personalized land website operations on said selected area of land alone.

4. The method of claim 3 further comprising:
extending said selected area of land to include said related land by including a buffer zone that extends said boundary at least partially circumscribing said selected area of land to include neighboring land.

5. The method of claim 3 further comprising:
extending said selected area of land to include related land by including other land with similar township, range and section designations as said selected area of land at least partially circumscribed by said boundary.

6. The method of claim 3 further comprising:
extending said selected area of land to include related land by including other land with similar geographic name designations as said selected area of land at least partially circumscribed by said boundary.

7. The method of claim 3 further comprising:
extending said selected area of land to include related land by including land defined by a designated set of geospatial coordinate points.

8. The method of claim 3 further comprising:
extending said selected area of land to include related land by including land defined by a designated list of street addresses.

9. The method of claim 1 further comprising:
searching electronically linked resources for said additional information related to said selected area of land;
retrieving said additional information related to said selected area of land; and
storing said additional information related to said selected area of land in said additional storage locations.

10. The method of claim 9 further comprising:
automatically searching said electronically linked resources for said additional information related to said selected area of land after said boundary at least partially circumscribing said selected area of land is created.

11. The method of claim 9 further comprising:
automatically searching said electronically linked resources for said additional information related to said selected area of land after said boundary at least partially circumscribing said selected area of land is modified.

12. The method of claim 9 further comprising:
continuously searching said electronically linked resources for said additional information related to said selected area of land.

13. The method of claim 12 wherein in said continuous searching is performed by at least one of the group comprising: a web bot, a web robot, a web crawler, and a web spider.

14. The method of claim 9 further comprising:
notifying an interested party when new additional information is found by said step of searching electronically linked resources.

15. The method of claim 14 wherein methods of notifying said interested party comprises at least one of the group consisting of: e-mail, instant message, text message, page, telephone call, and facsimile.

16. The method of claim 1 wherein said additional information related to said selected area of land comprises at least one of the group consisting of: text information, e-documents, additional map data, satellite image data, photographic data, title abstracts, title information, deed information, legal descriptions, leases, rights-of-way, surveys, watershed studies, other studies, easements, loan information, appraisal reports, grazing leases, insurance, conservation easements, ownership rights, public land leases, mineral rights of land, water rights of land, land titles, environmental audit, third party maps, insurance documents, improvements, leases, flood plain data, scanned documents, loan documents, loan information, right of way information, e-appraisal reports, webcam access links for viewing said selected area of land, video streaming access links for viewing said selected area of land, links to blog websites, links to Really Simple Syndication feeds, links to Rich Site Summary feeds, links to RDF (Resource Description Framework) Site Summary feeds, links to podcasts, and web access links for displaying data obtained from other sources.

17. The method of claim 1 further comprising:
allowing interested parties to order said additional information from said personalized land website.

18. The method of claim 1 further comprising:
ordering aerial images to be taken of said selected area of land; and
including said aerial images in said additional information related to said selected area of land;

19. The method of claim 1 further comprising:
ordering satellite images to be taken of said selected area of land; and
including said satellite images in said additional information related to said selected area of land.

20. The method of claim 1 further comprising:
notifying at least one third party that said personalized land website exists;
disclosing to said at least one third party a geospatial coordinate description of said boundary at least partially enclosing said selected area of land;
providing an interface for said at least one third party to send notification messages when said at least one third party obtains new information relating to said selected area of land; and
receiving said notification messages from said at least one third party informing said personalized land website that said at least one third party has said new information relating to said selected area of land.

21. The method of claim 20 further comprising:
notifying an interested party when said notification messages from said at least one third party are received about said new information relating to said selected area of land.

22. The method of claim 21 wherein methods of notifying said interested party comprises at least one of the group consisting of: e-mail, instant message, text message, page, telephone call, and facsimile.

23. The method of claim 1 wherein said boundary drawing tools permit a user to create said boundary at least partially around said selected area of land by hand on said personalized land website.

24. The method of claim 1 wherein said boundary drawing tools permit a user to create said boundary at least partially around said selected area of land automatically.

25. The method of claim 24 further comprising:
automatically creating a plurality of boundaries for a plurality of selected areas of land, each boundary of said plurality of boundaries designating a unique selected area of land of said plurality of selected areas of land;
automatically creating a plurality of personalized land websites such that there is a unique personalized land website for each selected area of land of said plurality of selected areas of land; and
storing each boundary of said plurality of boundaries on each personalized land website of said plurality of personalized websites such that there is one boundary of said plurality of boundaries stored on one personalized website of said plurality of personalized websites.

26. The method of claim 25 further comprising:
comparing said plurality of boundaries to determine if multiple boundaries have at least one matching attribute; and
merging said multiple boundaries into a single boundary if said multiple boundaries have at least one matching attribute.

27. The method of claim 26 wherein said matching attribute comprises at least one of the group consisting of: owner, co-owner, mailing address, property name, geographical feature, postal code, city name, geospatial coordinates, metes and bounds description, and township range and section.

28. The method of claim 25 further comprising:
comparing said plurality of boundaries to determine if multiple boundaries have at least one matching attribute;
creating a single personalized land website for said multiple boundaries if said multiple boundaries have at least one matching attribute; and
displaying said multiple boundaries on said single personalized land website and otherwise treating said multiple boundaries as a single boundary if said multiple boundaries have at least one matching attribute.

29. The method of claim 28 wherein said matching attribute comprises at least one of the group consisting of: owner, co-owner, mailing address, property name, geographical feature, postal code, city name, geospatial coordinates, metes and bounds description, and township range and section.

30. The method of claim 24 wherein said automatic creation of said boundary at least partially around said selected area of land is accomplished by scanning and analyzing an image that shows said boundary such that said boundary is transposed onto said map data.

31. The method of claim 24 wherein said automatic creation of said boundary at least partially around said selected area of land is accomplished by reading an electronic storage medium containing general boundary information and transposing said general boundary information onto said map data as said boundary.

32. The method of claim 31 wherein said electronic storage medium comprises at least one of the group consisting of: a text file, a database, a spreadsheet, and a structured data file.

33. The method of claim 25 further comprising:
creating a unique Uniform Resource Locator (URL) for each unique personalized land website of said plurality of personalized land websites by including a parcel identification string associated with said selected area of land of each unique personalized land website of said plurality of personalized land websites in said unique Uniform Resource Locator (URL).

34. The method of claim 25 further comprising:
creating a unique Uniform Resource Locator (URL) for each unique personalized land website of said plurality of personalized land websites by including a street address string associated with said selected area of land of each unique personalized land website of said plurality of personalized land websites in said unique Uniform Resource Locator (URL).

35. The method of claim 25 further comprising:
creating a unique Uniform Resource Locator (URL) for each unique personalized land website of said plurality of personalized land websites by including a unique random identification string associated with said selected area of land of each unique personalized land website of said plurality of personalized land websites in said unique Uniform Resource Locator (URL).

36. The method of claim 1 wherein said step of drawing a boundary at least partially around said selected area of land using said boundary drawing tools further comprises:
recording Global Positioning System (GPS) way point data for said selected area of land;
downloading said Global Positioning System (GPS) way point data for said selected area of land to a Global Positioning System (GPS) tool, said Global Positioning System (GPS) tool reads Global Positioning System (GPS) way point data and generates map coordinate data of said selected area of land;
transferring said map coordinate data of said selected area of land to said boundary drawing tools;
generating boundary data in said drawing tool based upon said map coordinate data of said selected area of land; and
creating said boundary at least partially around said selected area of land on said map data based upon said boundary data.

37. The method of claim 1 wherein said step of drawing a boundary at least partially around said selected area of land using said boundary drawing tools further comprises:
obtaining a metes and bounds description of said selected area of land;
reading a plurality of sets of metes and bounds data from said metes and bounds description of said selected area of land starting at a first set of metes and bounds data and progressing to a last set of metes and bounds data;
generating a plurality of subsets of boundary data by creating a subset of boundary data for each set of metes and bounds data of said plurality of sets of metes and bounds data;
generating boundary data by merging each subset of boundary data of said subsets of boundary data into said boundary data; and
creating said boundary at least partially around said selected area of land on said map data based upon said boundary data.

38. The method of claim 1 further comprising:
automatically generating a frame window around said boundary at least partially around said selected area of land that includes surrounding areas; and
displaying said frame window including said boundary at least partially around said selected area of land and said surrounding areas.

39. A personalized land website that provides an Internet accessible location for archiving a variety of information relating to a selected area of land comprising:
means for creating said Internet accessible location of said personalized land website;
means for providing map data over the Internet that relates to said selected area of land;
means for drawing a boundary at least partially around said selected area of land;
means for storing said map data as part of said personalized land website; and
means for providing additional storage locations as part of said personalized land website for storage of additional information relating to said area of land.

40. A method of generating a personalized land website at an Internet accessible location on the Internet, said personalized land website providing an interface for monitoring a selected area of land comprising:
creating said Internet accessible location of said personalized land website for monitoring said selected area of land;
providing map data over the Internet that relates to said selected area of land;
providing boundary drawing tools to allow a boundary to be circumscribed at least partially around said selected area of land on said map data;
drawing a boundary at least partially around said selected area of land using said boundary drawing tools;
monitoring a physical boundary and a physical land area at least partially enclosed by said physical boundary of said selected area of land corresponding to said boundary on said map data in order to detect changes to said selected area of land; and
notifying an interested party whenever said changes to said selected area of land are detected.

41. The method of claim 40 wherein said changes to said selected area of land comprise items crossing said physical boundary to enter and leave said selected area of land.

42. The method of claim 40 wherein said changes to said selected area of land comprise items moving within said physical land area of said selected area of land.

43. The method of claim 40 wherein said changes to said selected area of land comprise differences detected in photographs and images of said physical land area of said selected area of land, said photographs and images created between a first time and a second time such that said differences indicate physical alteration to said physical land area of said selected area of land.

44. The method of claim 40 further comprising:
extending said selected area of land to include neighboring land by including a buffer zone that extends said boundary at least partially circumscribing said selected area of land to include said neighboring land; and
performing said steps of monitoring said physical boundary and said physical area of land enclosed by said physical boundary for said selected area of land extended to include said neighboring land.

45. The method of claim 40 wherein systems of monitoring said physical boundary and said physical land area of said selected area of land to detect said changes to said selected area of land comprises at least one of the group consisting of: satellite surveillance of said physical boundary and within said physical land area of said selected area of land; analyzing satellite and aerial photographs and images of said selected area of land; motion detectors installed along said boundary and within said physical land area of said selected area of land; detection of Radio Frequency Identification (RFID) devices at said boundaries and within said physical land area said selected area of land; Global Positioning System (GPS) devices with communications capabilities tracked on the physical border and within said physical land area of said selected area of land, video surveillance of said boundary and within said physical land area of said selected area of land; and webcam surveillance of said boundary and within said physical land area of said selected area of land.

46. The method of claim 40 wherein methods of notifying said interested party comprises at least one of the group consisting of: e-mail, instant message, text message, page, telephone call, and facsimile.

47. A personalized land website that provides a management and supervisory interface via an Internet accessible location on the Internet for monitoring a selected area of land comprising:
means for creating said Internet accessible location of said personalized land website;
means for providing map data over the Internet that relates to said selected area of land;
means for drawing a boundary at least partially around said selected area of land;
means for monitoring a physical boundary and a physical land area at least partially enclosed by said physical boundary; and
means for notifying an interested party whenever changes to said selected area of land are detected.

48. A personalized land website that provides an Internet accessible location for archiving a variety of information relating to a selected area of land comprising:
map data that relates to said selected area of land;
additional information that relates to said selected area of land;
an Internet accessible computer system that provides an Internet location for said personalized land website including said map data that relates to said selected area of land and that allows users to view said map data and additional information relating to said selected area of land in Internet connected web browsers;
boundary drawing tools that draw a boundary at least partially around said selected area of land on said map data; and
at least one computer readable storage medium to store said personalized land website including said map data and said additional information.

49. The personalized land website of claim 48 wherein said boundary is comprised of a single geographic point partially enclosing said selected area of land to define said selected area of land.

50. The personalized land website of claim 48 further comprising:
a land extension tool that extends said selected area of land to include related land of said selected area of land such that personalized land website operations intended to be performed on said selected area of land are instead performed on said selected area of land extended to include said related land.

51. The personalized land website of claim 50 wherein said land extension tool extends said selected area of land to include said related land by including a buffer zone that extends said boundary at least partially circumscribing said selected area of land to include neighboring land.

52. The personalized land website of claim 50 wherein said land extension tool extends said selected area of land to include related land by including other land with similar township, range and section designations as said selected area of land at least partially circumscribed by said boundary.

53. The personalized land website of claim 50 wherein said land extension tool extends said selected area of land to include related land by including other land with similar geographic name designations as said selected area of land at least partially circumscribed by said boundary.

54. The personalized land website of claim 50 wherein said land extension tool extends said selected area of land to include related land by including land defined by a designated set of geospatial coordinate points.

55. The personalized land website of claim 50 wherein said land extension tool extends said selected area of land to include related land by including land defined by a designated list of street addresses.

56. The personalized land website of claim 48 further comprising:
a search tool that electronically searches linked resources for said additional information related to said selected area of land, retrieves said additional information related to said selected area of land, and stores said additional information related to said selected area of land in said additional storage locations.

57. The personalized land website of claim 56 wherein said search tool automatically searches said electronically linked resources for said additional information related to said selected area of land after said boundary at least partially circumscribing said selected area of land is created.

58. The personalized land website of claim 56 wherein said search tool automatically searches said electronically linked resources for said additional information related to said selected area of land after said boundary at least partially circumscribing said selected area of land is modified.

59. The personalized land website of claim 56 wherein said search tool continuously searches said electronically linked resources for said additional information related to said selected area of land.

60. The personalized land website of claim 59 wherein in said continuous searching is performed by at least one of the group comprising: a web bot, a web robot, a web crawler, and a web spider.

61. The personalized land website of claim 56 wherein said search tool further notifies an interested party when new additional information is found by said search tool.

62. The personalized land website of claim 61 wherein methods of notifying said interested party comprises at least one of the group consisting of: e-mail, instant message, text message, page, telephone call, and facsimile.

63. The personalized land website of claim 48 wherein said additional information related to said selected area of land comprises at least one of the group consisting of: text information, e-documents, additional map data, satellite image data, photographic data, title abstracts, title information, deed information, legal descriptions, leases, rights-of-way, surveys, watershed studies, other studies, easements, loan information, appraisal reports, grazing leases, insurance, conservation easements, ownership rights, public land leases, mineral rights of land, water rights of land, land titles, environmental audit, third party maps, insurance documents, improvements, leases, flood plain data, scanned documents, loan documents, loan information, right of way information, e-appraisal reports, webcam access links for viewing said selected area of land, video streaming access links for viewing said selected area of land, links to blog websites, links to Really Simple Syndication feeds, links to Rich Site Summary feeds, links to RDF (Resource Description Framework) Site Summary feeds, links to podcasts, and web access links for displaying data obtained from other sources.

64. The personalized land website of claim 48 further comprising:
an ordering tool that allows interested parties to order said additional information from said personalized land website.

65. The personalized land website of claim 48 further comprising:
an aerial image ordering tool that orders aerial images to be taken of said selected area of land and includes said aerial images in said additional information related to said selected area of land;

66. The personalized land website of claim 48 further comprising:
a satellite image ordering tool that orders satellite images to be taken of said selected area of land and includes said satellite images in said additional information related to said selected area of land.

67. The personalized land website of claim 48 further comprising:
a third party notification tool that:
notifies at least one third party that said personalized land website exists;
discloses to said at least one third party a geospatial coordinate description of said boundary at least partially enclosing said selected area of land;
provides an interface for said at least one third party to send notification messages when said at least one third party obtains new information relating to said selected area of land; and
receives said notification messages from said at least one third party informing said personalized land website that said at least one third party has said new information relating to said selected area of land.

68. The personalized land website of claim 67 wherein said third party notification tool further notifies an interested party when said notification messages from said at least one third party are received about said new information relating to said selected area of land.

69. The personalized land website of claim 68 wherein methods of notifying said interested party comprises at least one of the group consisting of: e-mail, instant message, text message, page, telephone call, and facsimile.

70. The personalized land website of claim 48 wherein said boundary drawing tools permit a user to create said boundary at least partially around said selected area of land by hand on said personalized land website.

71. The personalized land website of claim 48 wherein said boundary drawing tools permit a user to create said boundary at least partially around said selected area of land automatically.

72. The personalized land website of claim 71 wherein said boundary drawing tools further:
automatically create a plurality of boundaries for a plurality of selected areas of land, each boundary of said plurality of boundaries designates a unique selected area of land of said plurality of selected areas of land;
automatically create a plurality of personalized land websites such that there is a unique personalized land website for each selected area of land of said plurality of selected areas of land; and
stores each boundary of said plurality of boundaries on each personalized land website of said plurality of personalized websites such that there is one boundary of said plurality of boundaries stored on one personalized website of said plurality of personalized websites.

73. The personalized land website of claim 72 wherein said boundary drawing tools further:
compare said plurality of boundaries to determine if multiple boundaries have at least one matching attribute; and
merge said multiple boundaries into a single boundary if said multiple boundaries have at least one matching attribute.

74. The personalized land website of claim 73 wherein said matching attribute comprises at least one of the group consisting of: owner, co-owner, mailing address, property name, geographical feature, postal code, city name, geospatial coordinates, metes and bounds description, and township range and section.

75. The personalized land website of claim 72 wherein said boundary drawing tools further:
compare said plurality of boundaries to determine if multiple boundaries have at least one matching attribute;
create a single personalized land website for said multiple boundaries if said multiple boundaries have at least one matching attribute; and
display said multiple boundaries on said single personalized land website and otherwise treating said multiple boundaries as a single boundary if said multiple boundaries have at least one matching attribute.

76. The personalized land website of claim 75 wherein said matching attribute comprises at least one of the group consisting of: owner, co-owner, mailing address, property name, geographical feature, postal code, city name, geospatial coordinates, metes and bounds description, and township range and section.

77. The personalized land website of claim 71 wherein said automatic creation of said boundary at least partially around said selected area of land is accomplished by scanning and analyzing an image that shows said boundary such that said boundary is transposed onto said map data.

78. The personalized land website of claim 71 wherein said automatic creation of said boundary at least partially around said selected area of land is accomplished by reading an electronic storage medium containing general boundary information and transposing said general boundary information onto said map data as said boundary.

79. The personalized land website of claim 78 wherein said electronic storage medium comprises at least one of the group consisting of: a text file, a database, a spreadsheet, and a structured data file.

80. The personalized land website of claim 72 wherein said boundary tools further create a unique Uniform Resource Locator (URL) for each unique personalized land website of said plurality of personalized land websites by including a parcel identification string associated with said selected area of land of each unique personalized land website of said plurality of personalized land websites in said unique Uniform Resource Locator (URL).

81. The personalized land website of claim 72 wherein said boundary tools further create a unique Uniform Resource Locator (URL) for each unique personalized land website of said plurality of personalized land websites by including a street address string associated with said selected area of land of each unique personalized land website of said plurality of personalized land websites in said unique Uniform Resource Locator (URL).

82. The personalized land website of claim 72 wherein said boundary tools further create a unique Uniform Resource Locator (URL) for each unique personalized land website of said plurality of personalized land websites by including a unique random identification string associated with said selected area of land of each unique personalized land website of said plurality of personalized land websites in said unique Uniform Resource Locator (URL).

83. The personalized land website of claim 48 wherein in order to draw said boundary at least partially around said selected area of land said boundary drawing tools:
download Global Positioning System (GPS) way point data for said selected area of land from a Global Positioning System (GPS) tool that recorded said Global Positioning System (GPS) way point data for said selected area of land;
generate boundary data based upon said Global Positioning System (GPS) way point data for said selected area of land; and
create said boundary at least partially around said selected area of land on said map data based upon said boundary data.

84. The personalized land website of claim 48 wherein in order to draw said boundary at least partially around said selected area of land said boundary drawing tools:
read a plurality of sets of metes and bounds data from a metes and bounds description of said selected area of land starting at a first set of metes and bounds data and progressing to a last set of metes and bounds data;
generate a plurality of subsets of boundary data by creating a subset of boundary data for each set of metes and bounds data of said plurality of sets of metes and bounds data;
generate boundary data by merging each subset of boundary data of said subsets of boundary data into said boundary data; and
create said boundary at least partially around said selected area of land on said map data based upon said boundary data.

85. The personalized land website of claim 48 wherein in order to draw said boundary at least partially around said selected area of land said boundary drawing tools:
automatically generate a frame window around said boundary at least partially around said selected area of land that includes surrounding areas; and
displays said frame window including said boundary at least partially around said selected area of land and said surrounding areas.

86. A personalized land website that provides a management and supervisory interface via an Internet accessible location on the Internet for monitoring a selected area of land comprising:
map data that relates to said selected area of land;
an Internet accessible computer system that provides an Internet location for said personalized land website including said map data that relates to said selected area of land and that allows users to view said map data and additional information relating to said selected area of land in Internet connected web browsers;
boundary drawing tools that draw a boundary at least partially around said selected area of land on said map data; and
at least one computer readable storage medium to store said personalized land website including said map data;
a monitoring subsystem that monitors a physical boundary and a physical land area at least partially enclosed by said physical boundary of said selected area of land corresponding to said boundary on said map data in order to detect changes to said selected area of land; and
a notification subsystem that notifies an interested party whenever said changes to said selected area of land are detected.

87. The personalized land website of claim 86 wherein said changes to said selected area of land comprise items crossing said physical boundary to enter and leave said selected area of land.

88. The personalized land website of claim 86 wherein said changes to said selected area of land comprise items moving within said physical land area of said selected area of land.

89. The personalized land website of claim 86 wherein said changes to said selected area of land comprise differences detected in photographs and images of said physical land area of said selected area of land, said photographs and images created between a first time and a second time such that said differences indicate physical alteration to said physical land area of said selected area of land.

90. The personalized land website of claim 86 further comprising:
a land extension tool that extends said selected area of land to include neighboring land by including a buffer zone that extends said boundary at least partially circumscribing said selected area of land to include said neighboring land such that personalized land website operations intended to be performed on said selected area of land are instead performed on said selected area of land extended to include said neighboring land.

91. The personalized land website of claim 86 wherein systems of monitoring said physical boundary and said physical land area of said selected area of land to detect said changes to said selected area of land comprises at least one of the group consisting of: satellite surveillance of said physical boundary and within said physical land area of said selected area of land; analyzing satellite and aerial photographs and images of said selected area of land; motion detectors installed along said boundary and within said physical land area of said selected area of land; detection of Radio Frequency Identification (RFID) devices at said boundaries and within said physical land area said selected area of land; Global Positioning System (GPS) devices with communications capabilities tracked on the physical border and within said physical land area of said selected area of land, video surveillance of said boundary and within said physical land area of said selected area of land; and webcam surveillance of said boundary and within said physical land area of said selected area of land.

92. The personalized land website of claim 86 wherein methods of notifying said interested party comprises at least one of the group consisting of: e-mail, instant message, text message, page, telephone call, and facsimile.
